(19) United States
(12) Patent Application Publication
(10) Pub. No.: US 2023/0117740 A1
(43) Pub. Date: Apr. 20, 2023

(54) COMMODITY REGISTRATION DEVICE AND PROGRAM THEREFOR

(71) Applicant: TOSHIBA TEC KABUSHIKI KAISHA, Tokyo (JP)

(72) Inventors: Hikaru Komiyama, Yokohama Kanagawa (JP); Yumiko Okuma, Koganei Tokyo (JP)

(21) Appl. No.: 17/839,516

(22) Filed: Jun. 14, 2022

(30) Foreign Application Priority Data
Oct. 18, 2021 (JP) 2021-170173

(51) Int. Cl. G06Q 20/20

(52) U.S. Cl. CPC G06Q 20/207; G06Q 20/201

(57) ABSTRACT

A commodity registration device includes an input unit, a display unit, a receiving unit, and an output unit. Commodity data used to specify a transaction target commodity is input to the input unit. The display unit displays commodity details data including a tax rate of a tax imposed on the transaction target commodity specified by the commodity data input via the input unit. The receiving unit receives a tax rate change instruction for the tax imposed on the transaction target commodity for which the commodity details data is displayed on the display unit. The output unit outputs the commodity data used to specify the transaction target commodity for which the tax rate change instruction is received by the receiving unit.

### CROSS-REFERENCE TO RELATED APPLICATION

This application is based upon and claims the benefit of priority from Japanese Patent Application No. 2021-170173, filed on Oct. 18, 2021, the entire contents of which are incorporated herein by reference.

### FIELD

Embodiments described herein relate generally to a commodity registration device and a program therefor.

### BACKGROUND

In Japan, there are a standard tax rate and a reduced tax rate as tax rates of a tax imposed on a transaction such as sale of a commodity or provision of a service, a so-called consumption tax. The reduced tax rate is a tax rate applied to foods and beverages and the like excluding alcoholic beverages and eating-out. Accordingly, a retail store dealing in foods and beverages sells the foods and beverages other than alcoholic beverages by applying the reduced tax rate thereto and sells the alcoholic beverages by applying the standard tax rate thereto. However, if a customer (a purchaser) eats and drinks a food and a beverage in a seat in the store, a so-called eat-in area, this is regarded as eating-out. Therefore, not the reduced tax rate but the standard tax rate is applied in this case. Accordingly, if selling a food and a beverage other than an alcoholic beverage, a store clerk (a seller) asks the customer whether the customer intends to eat and drink in the eat-in area. The store clerk operates a commodity registration device to impose the standard tax rate to the food and the beverage that the customer answers to eat and drink in the eat-in area.

On the other hand, in recent years, a system in which, if a customer purchases a commodity in a selling floor where commodities are displayed, the customer scans a barcode attached to the commodity by himself or herself using an information terminal such as a smartphone, a tablet terminal, or the like, a so-called self-service commodity registration system has been spread. By introducing the self-service commodity registration system to a retail store where a selling floor and a checkout place are divided, commodity registration operation in the checkout place is made unnecessary. Therefore, there is an advantage that congestion in the checkout place can be reduced. Since contact of customers and store clerks decreases, the system is excellent in terms of measures against infectious diseases.

However, with the self-service commodity registration system, a store clerk cannot confirm intention of a customer about whether to eat and drink in an eat-in area.

Accordingly, in a retail store including an eat-in area, it is difficult to introduce the self-service commodity registration system.

### DESCRIPTION OF THE DRAWINGS

FIG. 1 is a block diagram illustrating a schematic configuration of a commodity registration system according to an embodiment;

FIG. 2 is a schematic diagram illustrating a main data structure of a commodity record stored in a commodity master;

FIG. 3 is a schematic diagram illustrating an example of a tax rate table;

FIG. 4 is a block diagram illustrating a main part circuit configuration of a registration support server;

FIG. 5 is a schematic diagram illustrating main data stored in a transaction file;

FIG. 6 is a block diagram illustrating a main part circuit configuration of an information terminal;

FIG. 7 is a schematic diagram illustrating the configuration of a list memory;

FIG. 8 is a schematic diagram illustrating the configuration of a total memory;

FIG. 9 is a schematic diagram illustrating the configuration of a tag table;

FIG. 10 is a flowchart illustrating a main part procedure of information processing executed by a processor of the information terminal;

FIG. 11 is a flowchart illustrating the main part procedure of the information processing;

FIG. 12 is a flowchart illustrating the main part procedure of the information processing;

FIG. 13 is a flowchart illustrating the main part procedure of the information processing;

FIG. 14 is a flowchart illustrating the main part procedure of the information processing;

FIG. 15 is a flowchart illustrating the main part procedure of the information processing;

FIG. 16 is a flowchart illustrating the main part procedure of the information processing;

FIG. 17 is a flowchart illustrating the main part procedure of the information processing;

FIG. 18 is a flowchart illustrating a specific procedure of details analysis processing in FIG. 11;

FIG. 19 is a flowchart illustrating a specific procedure of registration screen editing processing in FIG. 11;

FIG. 20 is a flowchart illustrating a main part procedure of check-in notification processing executed by a processor of the registration support server;

FIG. 21 is a flowchart illustrating a main part procedure of registration notification processing executed by the processor;

FIG. 22 is a flowchart illustrating a main part procedure of first change notification processing executed by the processor;

FIG. 23 is a flowchart illustrating a main part procedure of second change notification processing executed by the processor;

FIG. 24 is a flowchart illustrating a main part procedure of third change notification processing executed by the processor;

FIG. 25 is a flowchart illustrating a main part procedure of fourth change notification processing executed by the processor;

FIG. 26 is a flowchart illustrating a main part procedure of payment notification processing executed by the processor;

FIG. 27 is a flowchart illustrating a main part procedure of settlement request command reception processing executed by the processor;

FIG. 28 is a schematic diagram illustrating an example of a check-in screen displayed on a touch panel of the information terminal;

FIG. 29 is a schematic diagram illustrating an example of a registration screen displayed on the touch panel;

FIG. 30 is a schematic diagram illustrating an example of a scan screen displayed on the touch panel;

FIG. 31 is a schematic diagram illustrating an example of a registration screen displayed on the touch panel;

FIG. 32 is a schematic diagram illustrating an example of a registration screen displayed on the touch panel;

FIG. 33 is a schematic diagram illustrating an example of a number-of-articles change screen displayed on the touch panel;

FIG. 34 is a schematic diagram illustrating an example of a registration screen displayed on the touch panel;

FIG. 35 is a schematic diagram illustrating an example of an eat-in setting screen displayed on the touch panel;

FIG. 36 is a schematic diagram illustrating an example of an eat-in setting screen displayed on the touch panel;

FIG. 37 is a schematic diagram illustrating an example of an eat-in setting screen displayed on the touch panel;

FIG. 38 is a schematic diagram illustrating an example of a registration screen displayed on the touch panel;

FIG. 39 is a schematic diagram illustrating an example of a registration screen displayed on the touch panel;

FIG. 40 is a schematic diagram illustrating an example of an eat-in cancellation screen displayed on the touch panel;

FIG. 41 is a schematic diagram illustrating an example of an eat-in cancellation screen displayed on the touch panel;

FIG. 42 is a schematic diagram illustrating an example of a registration screen displayed on the touch panel; and

FIG. 43 is a schematic diagram illustrating an example of a checkout screen displayed on the touch panel.

### DETAILED DESCRIPTION

An aspect of embodiments is to, in order to solve the problems described above, provide a commodity registration device that can cope with a tax rate change of a tax imposed on a transaction target commodity without intention confirmation by a store clerk.

In an embodiment, a commodity registration device includes an input unit, a display unit, a receiving unit, and an output unit. Commodity data used to specify a transaction target commodity is input to the input unit. The display unit displays commodity details data including a tax rate of a tax imposed on the transaction target commodity specified by the commodity data input via the input unit. The receiving unit receives a tax rate change instruction for the tax imposed on the transaction target commodity for which the commodity details data is displayed on the display unit. The output unit outputs the commodity data used to specify the transaction target commodity for which the tax rate change instruction is received by the receiving unit.

An embodiment is explained below with reference to the drawings.

In this embodiment, in a selling floor of a retail store in which the selling floor where commodities are displayed and a checkout place where checkout machines are set are divided, a customer operates a portable information terminal by himself or herself and inputs a code of a purchase commodity, which is a transaction target commodity, to register the purchase commodity by himself or herself. In such a store, a commodity registration system adapted to a self-service is constructed. The information terminal is a form of a commodity registration device. As the information terminal, for example, an information terminal such as a smartphone carried by the customer, a dedicated portable terminal prepared in the store, and a tablet terminal attached to a shopping cart can be used. In this embodiment, the information terminal carried by the customer is explained as an example.

This embodiment is adapted to a consumption tax system in Japan at the time this application was filed. That is, a reduce tax rate of 8% is applied to foods and beverages excluding alcoholic beverages and eating-out. A standard tax rate of 10% is applied to other commodities. However, if a customer eats and drinks a food and a beverage in an eat-in area in the store without taking out the food and the beverage, that is, in the case of so-called eat-in, the standard tax rate of 10% is applied.

[Configuration Explanation of a Commodity Registration System]

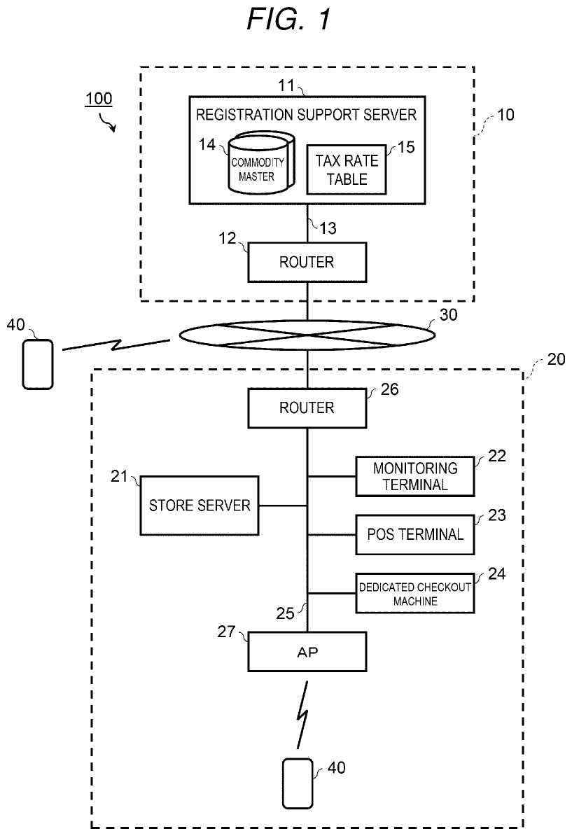

FIG. 1 is a block diagram illustrating a schematic configuration of a commodity registration system 100 according to this embodiment. The commodity registration system 100 includes a server system 10 that makes use of Cloud computing and a POS (Point Of Sales) system 20 constructed in a member store. The server system 10 and the POS system 20 enable bidirectional data communication through a network 30 that makes use of the Internet protocol. The network 30 is a wide-area network including a public line or a dedicated line as a relay network and including a wired LAN (Local Area Network), a wireless LAN, a mobile communication network, a cellular phone communication network, or the like as an access network. An information terminal 40 that makes use of the cellular phone communication network, for example, a smartphone, can access the server system 10 via the network 30.

The member store is a store having a use contract with a management company of the server system 10. In FIG. 1, the POS system 20 of one member store is illustrated. It goes without saying that POS systems of other member stores are also connected to the network 30. However, the POS systems of the other member stores do not always have the same configuration as the configuration of the POS system 20 illustrated in FIG. 1. A part of the configurations of the POS systems can be different depending on the member stores.

The server system 10 includes a registration support server 11 and a router 12, which are connected by a communication line 13. The route 12 is connected to the network 30 as well and functions as a relay base for data communication between the registration support server 11 and the POS systems 20 of the member stores via the network 30.

The registration support server 11 is a computer for supporting a registration job for a transaction target commodity, that is, a purchase commodity of a customer who does shopping in a member store. For the support, the registration support server 11 includes at least two functions explained below. A first function is a function of performing registration processing for commodity sales data based on a code of a purchase commodity input by the information terminal 40. A second function is a function of, according to a checkout instruction from the information terminal 40, creating or transmitting checkout data necessary for settlement of a transaction with a customer who uses the information terminal 40.

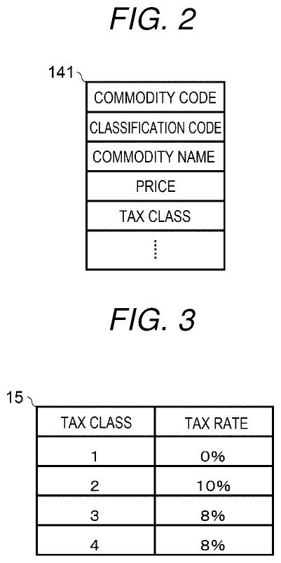

The registration support server 11 manages a commodity master 14 for each of the member stores in order to realize the first function. The commodity master 14 is an aggregate of a commodity record 141 (see FIG. 2) created for each of commodities. The registration support server 11 manages a tax rate table 15. The tax rate table 15 is shared by the member stores.

FIG. 2 is a schematic diagram illustrating a main data structure of the commodity record 141. As illustrated, the commodity record 141 is a data record in which commodity information such as a commodity code, a classification code, a commodity name, a price, and a tax class is recorded. The commodity code is a unique code set for each of commodities in order to identify the commodities.

The classification code is a unique code set for each of classifications of the commodities. Classifications of foods and beverages include vegetable, fruit, meat, fish, beverage, dairy product, processed food, confectionery, and alcoholic beverage. Divisions of the classifications are not limited to this. At least a commodity specified by the commodity code belongs to any one of the classifications. The commodity name and the price are a specific name and a normal price per one article of the commodity specified by the commodity code.

The tax class is information for identifying a tax type of a tax imposed on a commodity. As the tax type, there are four types of tax free, standard tax rate taxation, reduced tax rate taxation un-adapted to eat-in, and reduced tax rate taxation adapted to eat-in. In this embodiment, a tax class of the tax free is represented as “1”. A tax class of the standard tax rate taxation is represented as “2”. A tax class of the reduced tax rate taxation un-adapted to eat-in is represented as “3”. A tax class of the reduced tax rate taxation adapted to eat-in is represented as “4”. Therefore, the tax class “1” is set for the commodity record 141 of a tax free commodity such as a coupon, a gift voucher, or a prepaid card. The tax class “2” is set for the commodity record 141 of a commodity belonging to the alcoholic beverage and a commodity other than the foods and beverages. The tax class “3” is set for the commodity record 141 of foods and beverages not easily eaten and drunk in the eat-in area among the foods and beverages other than the alcoholic beverages, for example, rice, vegetable and fruit, meat, fish, dried food, and seasoning. The tax class “4” is set for the commodity record 141 of foods and beverages that are allowed to be eaten and drunk in the eat-in area among the foods and beverages other than the alcoholic beverages, for example, box lunch, bread, daily dish, and instant food.

FIG. 3 is a schematic diagram illustrating an example of the tax rate table 15. As illustrated, the tax rate table 15 stores a tax rate “0%” in correlation with the tax class “1” of the tax free, stores a tax rate “10%” in correlation with the tax class “2” of the standard tax rate taxation, stores a tax rate “8%” in correlation with the tax class “3” of the reduced tax rate taxation un-adapted to eat-in, and stores a tax rate “8%” in correlation with the tax class “4” of the reduced tax rate taxation adapted to eat-in. The tax classes and the tax rates corresponding thereto are not limited to those illustrated in FIG. 3 and can be changed as appropriate according to a tax system.

Referring back to FIG. 1, the POS system 20 includes a store server 21, a monitoring terminal 22, a POS terminal 23, and a dedicated checkout machine 24, which are connected by an intra-store network 25. In the POS system 20, a router 26 is connected to the intra-store network 25. The POS system 20 is connected to the network 30 via the router 26. Further, in the POS system 20, an access point 27 is connected to the intra-store network 25. The POS system 20 enables data communication by a wireless LAN with the information terminal 40 via the access point 27.

The store server 21 is a computer for managing, based on information concerning a transaction settled by a member store in which the POS system 20 is constructed, sales information of the member store, stock information and order information of commodities, and the like.

The monitoring terminal 22 is a terminal for monitoring a customer who is performing code reading operation for a purchase commodity by himself or herself using the information terminal 40. The monitoring terminal 22 includes a monitor. An action of a customer in the store, data relating to a purchase commodity of the customer, and the like are displayed on the monitor.

The POS terminal 23 is a checkout machine that processes settlement of a transaction with a customer who does not use the information terminal 40. A store clerk is an operator of the POS terminal 23. The POS terminal 23 may be a semi-self-service type POS terminal separated into a registration machine and a checkout machine, the store clerk operating the registration machine and the customer operating the checkout machine. The POS terminal 23 may be a full-self-service type POS terminal operated by the customer.

The dedicated checkout machine 24 is a checkout machine that processes settlement of a transaction with a customer who uses the information terminal 40. The customer is an operator of the dedicated checkout machine 24. The dedicated checkout machine 24 includes a function of scanning a barcode for checkout displayed on the information terminal 40, a payment processing function adapted to various payment methods such as electronic money, a credit card, and cash, and an electronic money charging function.

[Configuration Example of the Registration Support Server]

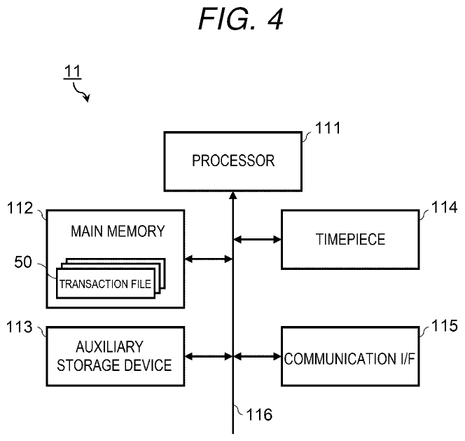

FIG. 4 is a block diagram illustrating a main part circuit configuration of the registration support server 11. The registration support server 11 includes a processor 111, a main memory 112, an auxiliary storage device 113, a timepiece 114, a communication interface 115, and a system transmission line 116. The system transmission line 116 includes an address bus, a data bus, and a control signal line. In the registration support server 11, the processor 111, the main memory 112, the auxiliary storage device 113, the timepiece 114, and the communication interface 115 are connected to the system transmission line 116. In the registration support server 11, a computer is configured by the processor 111, the main memory 112, the auxiliary storage device 113, the timepiece 114, and the communication interface 115 and the system transmission line 116 connecting the foregoing.

The processor 111 is equivalent to a central part of the computer. The processor 111 controls the units in order to realize the various functions of the registration support server 11 according to an operating system or application programs (application software). The processor 111 is, for example, a CPU (Central Processing Unit).

The main memory 112 is equivalent to a main storage part of the computer. The main memory 112 includes a nonvolatile memory region and a volatile memory region. The main memory 112 stores the operating system or the application programs in the nonvolatile memory region. The main memory 112 stores, in the volatile memory region, data necessary for the processor 111 in executing processing for controlling the units. The data is sometimes stored in the nonvolatile memory region. The main memory 112 uses the volatile memory region as a work area where data is rewritten as appropriate by the processor 111. The nonvolatile memory region is, for example, a ROM (Read Only Memory). The volatile memory region is, for example, a RAM (Random Access Memory).

The auxiliary storage device 113 is equivalent to an auxiliary storage part of the computer. For example, an EEPROM (Electric Erasable Programmable Read-Only Memory), a HDD (Hard Disc Drive), an SSD (Solid State Drive), or the like can be the auxiliary storage device 113. The auxiliary storage device 113 saves, for example, data used by the processor 111 in performing various kinds of processing or data created by processing in the processor 111. The auxiliary storage device 113 sometimes stores the application programs.

The timepiece 114 clocks a date and time. The registration support server 11 acquires, as a date and time at the present point in time, the date and the time clocked by the timepiece 114.

The communication interface 115 is a circuit for performing transmission and reception of data according to a predetermined communication protocol between the registration support server 11 and various kinds of equipment connected via the network 30.

The registration support server 11 uses a part of a volatile region in the main memory 112 as a storage region of a plurality of transaction files 50. The transaction file 50 is created for each customer who performs code reading operation for a purchase commodity, which is a transaction target commodity, using the information terminal 40. Various data necessary for creation of checkout data are stored in the transaction file 50.

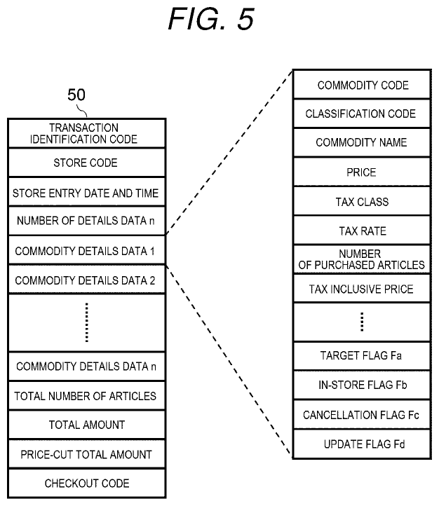

FIG. 5 is a schematic diagram illustrating main data stored in the transaction file 50. FIG. 5 illustrates, as an example, data of one record among a plurality of transaction records stored in the transaction file 50. The transaction file 50 stores data relating to a transaction of a customer who uses the information terminal 40. As illustrated in FIG. 5, a transaction identification code, a store code, a store entry date and time, the number of details data n, commodity details data as many as the number n, a total number of articles, a total amount, a price-cut total amount, a checkout code, and the like are stored in the transaction file 50.

The transaction identification code is information for identifying a transaction of a customer. The transaction identification code may be, for example, a code for identifying the information terminal 40 used by the customer. For example, an equipment ID of the information terminal 40 and a cellular phone number can be the transaction identification code. The transaction identification code may be, for example, a transaction number for identifying a transaction or may be, in addition to the transaction number, a combination of a store code and date and time information such as a store entry date and time. The registration support server 11 issues the transaction number, for example, if generating a transaction file explained below. The store code is a unique code set for each of member stores in order to individually identify the member stores. The store entry date and time is a date and time when the customer starts an application for a commodity registration system operating in the information terminal 40 and checks in the member store.

The commodity details data is configured by a commodity code, a classification code, a commodity name, a price, a tax class, the number of purchased articles, a tax inclusive price, and the like of a purchase commodity. The commodity code, the classification code, the commodity name, the price, and the tax class are information of the commodity record 141. The tax inclusive price is a tax inclusive sales price calculated according to the price, a tax rate corresponding to the tax class, and the number of purchased articles.

The commodity details data further includes a target flag Fa, an in-store flag Fb, a cancellation flag Fc, and an update flag Fd. The target flag Fa is 1-bit data for identifying whether a tax type of the purchase commodity is the reduced tax rate taxation adapted to eat-in. In this embodiment, the target flag Fa in the case in which the tax type of the purchase commodity is the reduced tax rate taxation adapted to eat-in is represented as “1” and the target flag Fa in the case in which the tax type of the purchase commodity is a tax type other than the reduced tax rate taxation adapted to eat-in is represented as “0”. The in-store flag Fb is 1-bit data for identifying whether the customer eats and drinks the purchase commodity, the tax type of which is the reduced tax rate taxation adapted to eat-in, in the eat-in area. In this embodiment, the in-store flag Fb in the case in which the customer eats and drinks in the eat-in area is represented as “1” and the in-store flag Fb in the case in which the customer does not eat and drink in the eat-in area is represented as “0”. The cancellation flag Fc is 1-bit data for identifying whether the customer cancels eating and drinking of the purchase commodity, the tax type of which is the reduced tax rate taxation adapted to eat-in, in the eat-in area. In this embodiment, the cancellation flag Fc in the case in which the eating and drinking is cancelled is represented as “1” and the cancellation flag Fc in the case in which the eating and drinking is not cancelled is represented as “0”. The update flag Fd is 1-bit data for identifying whether the commodity details data is updated data. In this embodiment, the update flag Fd of updated commodity details data is represented as “1” and the update flag Fd of un-updated commodity details data is represented as “0”.

The total number of articles is the number of articles obtained by totaling the numbers of purchased articles of respective commodity details data. The total amount is an amount obtained by totaling tax inclusive prices of the respective commodity details data. The price-cut total amount is an amount obtained by totaling price-cut amounts of purchased commodities. The checkout code is a code used by, in checkout of a transaction, a customer who checks in, at the store entry date and time, the member store specified by the store code using the information terminal 40.

[Configuration Explanation of the Information Terminal]

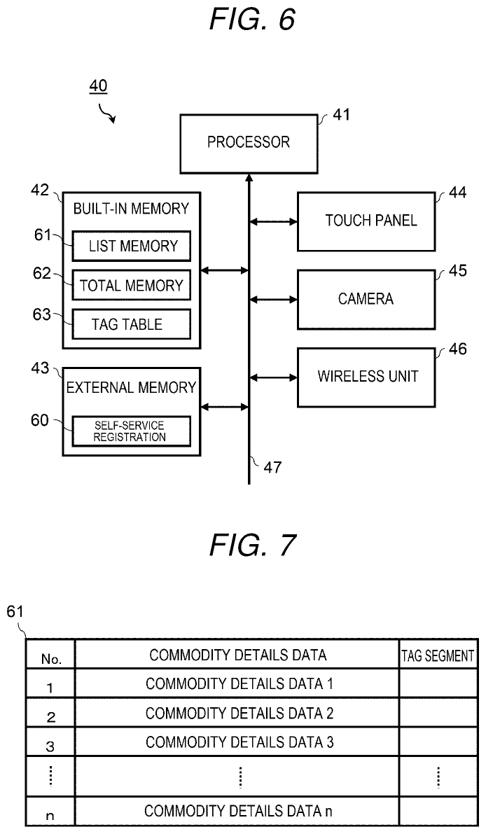

FIG. 6 is a block diagram illustrating a main part circuit configuration of the information terminal 40. As illustrated in FIG. 6, the information terminal 40 includes a processor 41, a built-in memory 42, an external memory 43, a touch panel 44, a camera 45, a wireless unit 46, and a system transmission line 47.

The system transmission line 47 includes an address bus, a data bus, and a control signal line. In the information terminal 40, the processor 41, the built-in memory 42, the external memory 43, the touch panel 44, the camera 45, and the wireless unit 46 are connected to the system transmission line 47. In the information terminal 40, a computer is configured by the processor 41, the built-in memory 42, and the external memory 43 and the system transmission line 47 connecting the forgoing.

The processor 41 is equivalent to a central part of the computer. The processor 41 controls the units in order to realize various functions of the information terminal 40 according to an operating system or application programs (application software). The processor 41 is, for example, a CPU.

The built-in memory 42 is equivalent to a main storage part of the computer. The built-in memory 42 includes a nonvolatile memory region and a volatile memory region. The built-in memory 42 stores the operating system or the application programs in the nonvolatile memory region. The built-in memory 42 stores, in the volatile memory region, data necessary for the processor 41 in executing processing for controlling the units. The built-in memory 42 uses the volatile memory region as a work area where data is rewritten as appropriate by the processor 41. The nonvolatile memory region is, for example, a ROM. The volatile memory region is, for example, a RAM.

The external memory 43 is equivalent to an auxiliary storage part of the computer. For example, an SD memory card and a USB memory can be the external memory 43. The external memory 43 saves, for example, data used by the processor 41 in performing various kinds of processing or data created by processing in the processor 41. The external memory 43 sometimes stores the application programs.

The touch panel 44 is a device obtained by combining a display functioning as a display unit and a touch sensor functioning as a detecting unit. The display includes a screen for displaying various images. The touch sensor detects a position on the screen touched by the operator. The touch panel 44 acquires, from the position on the screen detected by the touch sensor and information concerning an image displayed in the position, data input by the operator.

The camera 45 is an imaging device incorporated in the information terminal 40. The processor 41 includes a function of a reading unit that reads a code such as a barcode or a two-dimensional code from an image captured by the camera 45. Barcodes representing commodity codes of commodities in a predetermined barcode system are attached to the commodities. That is, the processor 41 can acquire a commodity code of a purchase commodity by reading a barcode attached to the commodity from an image captured by the camera 45.

The wireless unit 46 is a communication device that performs data communication according to a communication protocol of a wireless LAN between the communication device and the access point 27. The wireless unit 46 configures a communication unit of the information terminal 40.

In the information terminal 40 having such a configuration, for example, a self-service registration program 60 is installed in the external memory 43. The self-service registration program 60 is application software for the commodity registration system to be executed in the information terminal 40. The self-service registration program 60 may be installed in the built-in memory 42. A method of installing the self-service registration program 60 in the built-in memory 42 or the external memory 43 is not particularly limited. The self-service registration program 60 can be installed in the built-in memory 42 or the external memory 43 by recording the self-service registration program 60 in a removable recording medium or distributing the self-service registration program 60 with communication via a network. A form of the recording medium does not matter if the recording medium can store a program and can be read by a device like an SD memory card, a USB memory, or the like.

In the information terminal 40 in which the self-service registration program 60 is installed, a part of a region of the built-in memory 42 is set as a region of a list memory 61, a total memory 62, and a tag table 63. The list memory 61, the total memory 62, and the tag table 63 may be formed in the external memory 43.

FIG. 7 is a schematic diagram illustrating the configuration of the list memory 61. As illustrated, the list memory 61 includes areas for storing commodity details data and a tag segment in association with a series of list numbers. The area of the commodity details data stores the commodity details data stored in the transaction file 50 including the transaction identification code for identifying the transaction of the customer who uses the information terminal 40. The area of the tag segment stores a tag segment, which is identification information of a tag attached if a commodity name, a tax inclusive price, and the like of the commodity details data are displayed on the touch panel 44 in a list format. Details of the tag are explained below.

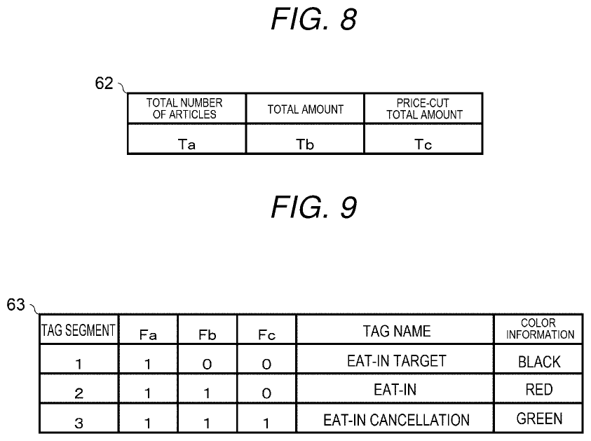

FIG. 8 is a schematic diagram illustrating the configuration of the total memory 62. As illustrated, the total memory 62 includes areas for storing a total number of articles Ta, a total amount Tb, and a price-cut total amount Tc. The area of the total number of articles Ta stores the total number of articles stored in the transaction file 50 including the transaction identification code for identifying the transaction of the customer who uses the information terminal 40. The area of the total amount Tb stores the total amount stored in the transaction file 50. The area of the price-cut total amount Tc stores the price-cut total amount stored in the transaction file 50.

FIG. 9 is a schematic diagram illustrating the configuration of the tag table 63. As illustrated, the tag table 63 includes a column of a tag segment, a column of the target flag Fa, a column of the in-store flag Fb, a column of the cancellation flag Fc, a column of a tag name, and a column of color information.

In this embodiment, a tag record in which, in the tag segment “1”, the target flag Fa is “1”, the in-store flag Fb is “0”, the cancellation flag Fc is “0”, the tag name is “eat-in target”, and the color information is “black” is stored. That is, the tag segment “1” is information for identifying a tag “eat-in target” in black characters attached to information of a purchase commodity, a tax type of which is the reduced tax rate taxation adapted to eat-in and for which a declaration for eating and drinking in the eat-in area, that is, a so-called eat-in declaration is not performed.

In this embodiment, a tag record in which, in the tag segment “2”, the target flag Fa is “1”, the in-store flag Fb is “1”, the cancellation flag Fc is “0”, the tag name is “eat-in”, and the color information is “red” is stored. That is, the tag segment “2” is information for identifying a tag “eat-in” in red characters attached to information of a purchase commodity, a tax type of which is the reduced tax rate taxation adapted to eat-in and for which the eat-in declaration is performed.

In this embodiment, a tag record in which, in the tag segment “3”, the target flag Fa is “1”, the in-store flag Fb is “1”, the cancellation flag Fc is “1”, the tag name is “eat-in cancellation”, and the color information is “green” is stored. That is, the tag segment “3” is information for identifying a tag “eat-in cancellation” in green characters attached to information of a purchase commodity, a tax type of which is the reduced tax rate taxation adapted to eat-in and for which cancellation of the eat-in declaration is performed.

The tag name and the color information are not limited to those illustrated in FIG. 9. Appropriate tag names and color information are set by a system administrator, a user, or the like. The color information may be omitted.

[Operation Explanation of the Commodity Registration System]

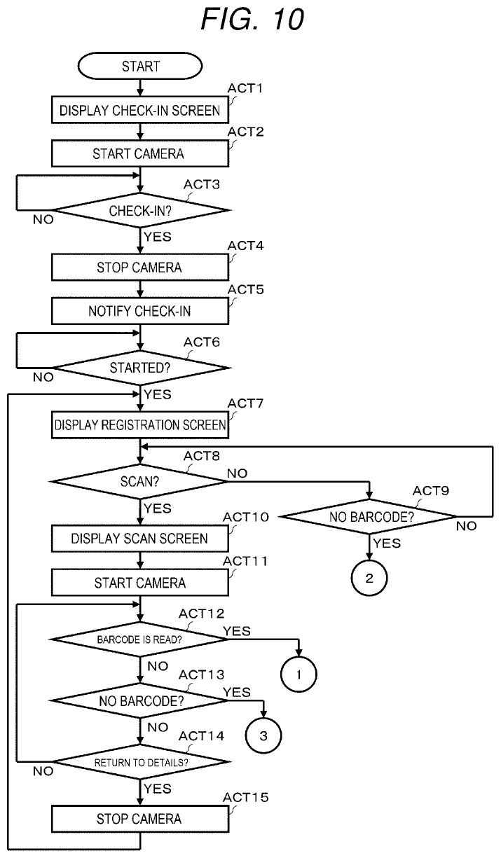

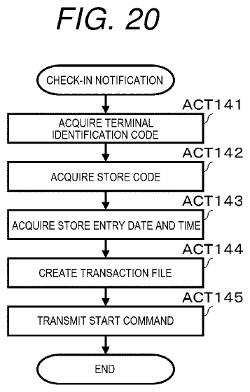

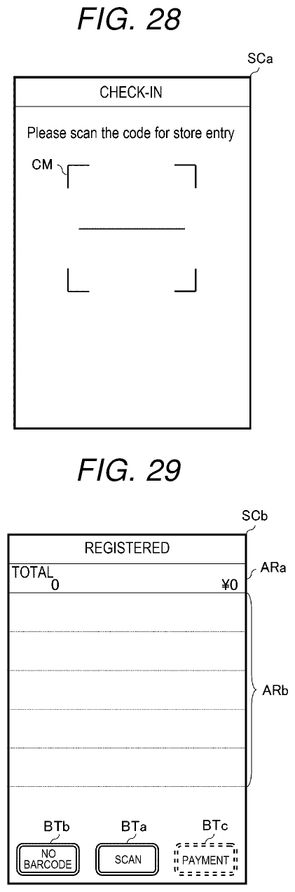

FIGS. 10 to 19 are flowcharts illustrating a main part procedure of information processing executed by the processor 41 of the information terminal 40 according to the self-service registration program 60. FIGS. 20 to 27 are flowcharts illustrating a main part procedure of information processing executed by the processor 111 of the registration support server 11 according to a program. FIGS. 28 to 43 are transition examples of screens displayed on the touch panel 44 of the information terminal 40. A main operation of the commodity registration system 100 is explained with reference to the drawings. A procedure and content of the operation explained below are examples. The procedure or the content can be changed as appropriate if the same effects can be achieved. The screens are examples. Layouts, images, texts, and the like of the screens are not limited to those illustrated in the figures.

First, a customer who does shopping using the information terminal 40 in a retail store in which the commodity registration system 100 is constructed starts the self-service registration program 60. If the self-service registration program 60 is started, the processor 41 of the information terminal 40 starts the information processing of the procedure illustrated in FIG. 10. In ACT 1, the processor 41 causes the touch panel 44 to display a check-in screen SCa (see FIG. 28). In ACT 2, the processor 41 starts the camera 45.

A code for store entry is prepared in an entrance of the store. The code for store entry is obtained by encoding setting information relating to the store with a two-dimensional code system. The setting information includes a store code, in-store LAN data, and mobile communication data. The in-store LAN data is an SSID, a password, security information, and the like necessary for the information terminal 40 to be connected to the access point 27 using a wireless LAN. The mobile communication data is a timeout time, the number of times of retry, and the like necessary for the information terminal 40 to communicate with the respective kinds of equipment of the commodity registration system 100.

FIG. 28 is an example of the check-in screen SCa. As illustrated, on the check-in screen SCa, a frame CM indicating a code reading region is disposed together with guidance for guiding scanning of the code for store entry. The customer holds the camera 45 of the information terminal 40 over the code for store entry such that the code for store entry fits in the frame CM. Then, the code for store entry is read by the function of the reading unit of the information terminal 40.

In the above explanation, the camera 45 starts at timing when the check-in screen SCa is displayed on the touch panel 44. However, the timing when the camera 45 starts is not limited to this. For example, a camera start button may be displayed on the check-in screen SCa. If the camera start button is touched, the camera 45 may start.

In ACT 3, the processor 41 that caused the touch panel 44 to display the check-in screen SCa waits for check-in. If the code for store entry is scanned by the camera 45, the processor 41 recognizes that check-in is performed and proceeds to ACT 4. In ACT 4, the processor 41 stops the camera 45.

In ACT 5, the processor 41 controls the wireless unit 46 to perform check-in notification. According to the control, the wireless unit 46 is connected to the access point 27 by the wireless LAN based on the in-store LAN data acquired from the code for store entry. After being connected to the access point 27, the wireless unit 46 wirelessly transmits a check-in notification command. The check-in notification command is received by the access point 27 and transmitted to the registration support server 11 via the router 26 of the POS system 20. A terminal identification code set in the information terminal 40 is included in the check-in notification command. The terminal identification code may be, for example, a code for identifying the information terminal 40 used by the customer. For example, an equipment ID of the information terminal 40 and a cellular phone number can be the terminal identification code. Alternatively, the terminal identification code may be a code for identifying the self-service registration program 60 stored in the information terminal 40 or a user who uses the program. The terminal identification code may be, for example, a specific number automatically issued if the program is installed or a member number issued at the time of member registration by the customer. A store code acquired from the code for store entry is also included in the check-in notification command. Check-in notification processing is executed in the registration support server 11 that receives the check-in notification command.

FIG. 20 is a flowchart illustrating a main part procedure of the check-in notification processing. If receiving the check-in notification command via the communication interface 115, in ACT 141, the processor 111 of the registration support server 11 acquires the terminal identification code from the check-in notification command. In ACT 142, the processor 111 acquires a store ID from the check-in notification command. Further, in ACT 143, the processor 111 sets, as a store entry date and time, the present date and time clocked by the timepiece 114. In ACT 144, the processor 111 creates the transaction file 50. In the transaction file 50, the transaction identification code, the store code acquired from the check-in notification command, and the store entry date and time are saved. The transaction identification code may be the terminal identification code acquired from the check-in notification command. The transaction identification code may be a transaction umber. The transaction file 50 is stored in, for example, the main memory 112.

In ACT 145, the processor 111 transmits, for example, based on the terminal identification code, a start command to the information terminal 40 at a check-in notification command transmission source. If a transaction number is used in the transaction identification code, the processor 111 may transmit, to the information terminal 40, the start command including the transaction identification code in which the transaction number is used. In this case, if the commodity is registered, the information terminal 40 can include the transaction identification code in a registration notification command explained below. The registration support server 11 can manage, based on the transaction identification code, information conceding the commodity registered by the customer.

Then, the processor 111 ends the information processing at the time when the check-in notification command is received. The processor 111 creates the transaction file 50 in ACT 144. However, timing for creating the transaction file 50 is not limited to this. The processor 111 may generate the transaction file 50 if receiving a commodity code transmitted as a registration command if the information terminal 40 reads a barcode of a first commodity in a new transaction.

Referring back to FIG. 10, in ACT 6, the processor 41 that performed the check-in notification waits for a start command. If receiving the start command via the wireless unit 46, the processor 41 proceeds to ACT 7. In ACT 7, the processor 41 switches the screen of the touch panel 44 from the check-in screen SCa to a registration screen SCb (see FIG. 29).

FIG. 29 is an example of the registration screen SCb. As illustrated, a scan button BTa, a no-barcode button BTb, and a payment button BTc are disposed on the registration screen SCb. A part of the screen is set as a total display section ARa for a transaction and the remaining part of the screen is set as a details list display section ARb for purchase commodities. The positions of the total display section ARa and the details list display section ARb are fixed. In this embodiment, the details list display section ARb is divided into five details areas to make it possible to display information, for example, commodity names, the numbers of purchased articles, and tax inclusive prices concerning purchase commodities of five items at most. If purchase commodities exceed five items, commodity names and the like are not displayed any more in the details list display section ARb in order from the purchase commodity registered earliest. However, for example, by swiping the details list display section ARb, information concerning purchase commodities registered early can be displayed in the details list display section ARb. Since shopping is not started at the present point in time, the total number of articles is 0 and the total amount is 0 yen. Details areas of the details list display section ARb are blank.

The scan button BTa is an operation element for instructing scanning of a barcode attached to a commodity. The no-barcode button BTb is an operation element for instructing registration of a commodity to which a barcode is not attached. The payment button BTc is an operation element for instructing price payment for a transaction. Since shopping is not started at the present point in time, the payment button BTc is grayed out and invalidated. The registration screen SCb on which the payment button BTc is invalidated may be referred to as a registration start screen.

The customer who confirmed the registration screen SCb starts shopping. The customer walks around the selling floor and, if finding a purchase commodity, checks whether a barcode is attached to the purchase commodity. If a barcode is attached to the purchase commodity, the customer touches the scan button BTa. If a barcode is not attached to the purchase commodity, the customer touches the no-barcode button BTb.

The processor 41 that controlled the display on the registration screen SCb waits for the scan button BTa to be touched in ACT 8 or the no-barcode button BTb to be touched in ACT 9.

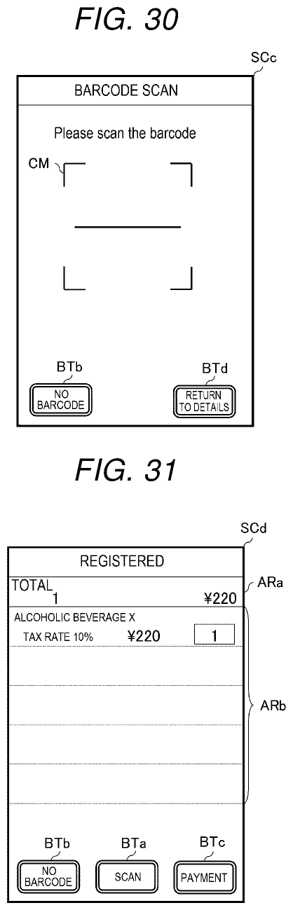

If the scan button BTa is touched in the waiting state in ACT 8 and ACT 9, the processor 41 proceeds to ACT 10. In ACT 10, the processor 41 switches the screen of the touch panel 44 from the registration screen SCb to a scan screen SCc (see FIG. 30). In ACT 11, the processor 41 starts the camera 45.

FIG. 30 is an example of the scan screen SCc. As illustrated, on the scan screen SCc, a frame CM indicating a code reading region is disposed together with guidance for guiding barcode scan for a commodity. On the scan screen SCc, the no-barcode button BTb and a return-to-details button BTd are disposed. The return-to-details button BTd is an operation element for instructing to return the screen of the touch panel 44 to the registration screen SCb. The code reading region is an image for supporting barcode reading.

The customer who checked the scan screen SCc holds the camera 45 of the information terminal 40 over the purchase commodity such that the barcode fits on the inner side of the frame CM. Then, the barcode is read by the function of the reading unit of the information terminal 40. If a barcode is not attached to the purchase commodity, the customer touches the no-barcode button BTb. If returning the screen of the touch panel 44 to the registration screen SCb, the customer touches the return-to-details button BTd.

The processor 41 that started the camera 45 in ACT 11 waits for a barcode to be read in ACT 12, the no-barcode button BTb to be touched in ACT 13, or the return-to-details button BTd to be touched in ACT 14.

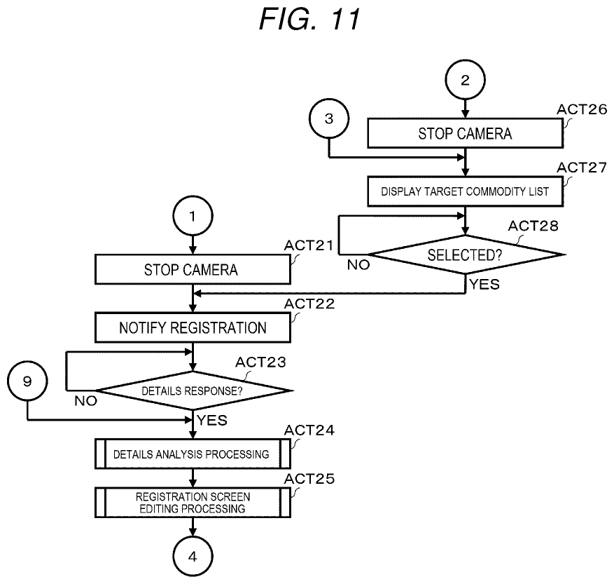

If a barcode is read in the waiting state in ACT 12 to ACT 14, the processor 41 proceeds to ACT 21 in FIG. 11. In ACT 21, the processor 41 stops the camera 45. In ACT 22, the processor 41 controls the wireless unit 46 to perform registration notification. According to the control, the wireless unit 46 wirelessly transmits a registration notification command. The registration notification command is received by the access point 27 and transmitted to the registration support server 11 via the router 26 of the POS system 20. Data of the barcode read from the purchase commodity is included in the registration notification command. A transaction identification code, which is information for identifying a transaction of a customer in the transaction file 50, is included in the registration notification command. For example, if the transaction identification code is a terminal identification code, the terminal identification code set in the information terminal 40 is included in the registration notification command. Registration notification processing is executed in the registration support server 11 that received the registration notification command.

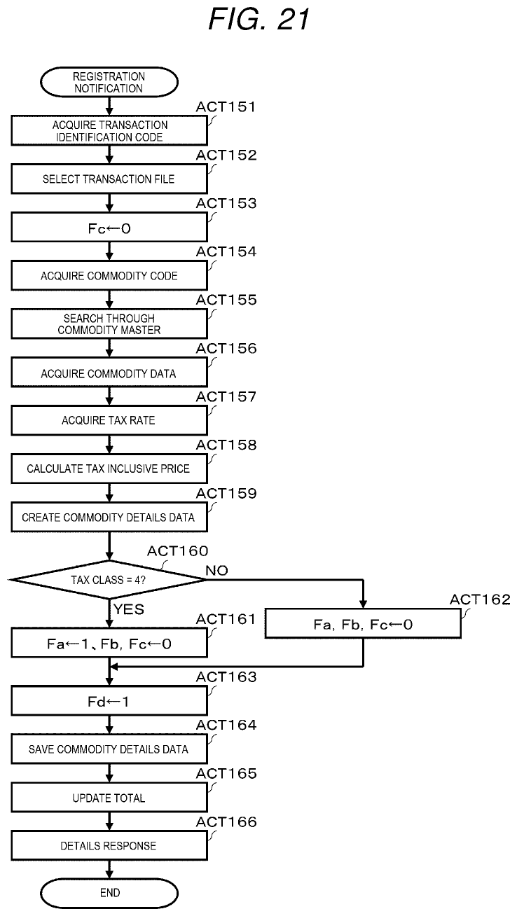

FIG. 21 is a flowchart illustrating a main part procedure of the registration notification processing. If receiving the registration notification command via the communication interface 115, in ACT 151, the processor 111 of the registration support server 11 acquires a transaction identification code from the registration notification command. In ACT 152, the processor 111 selects the transaction file 50 in which the transaction identification code is saved. In the following explanation, for convenience of explanation, the selected transaction file 50 is referred to as a transaction file 51.

In ACT 153, the processor 111 sets all of update flags Fd of commodity details data stored in the transaction file 51 to “0”. Subsequently, in ACT 154, the processor 111 acquires a commodity code from data of a barcode included in the registration notification command. In ACT 155, the processor 111 searches through the commodity master 14 with the commodity code. At this time, the processor 111 searches through the commodity master 14 of a member store identified by a store code saved in the transaction file 51.

In ACT 156, the processor 111 reads out, from the commodity master 14, commodity data such as a classification code, a commodity name, a price, and a tax class stored in correlation with the commodity code. In ACT 157, the processor 111 acquires a tax rate associated with the tax class included in the commodity data referring to the tax rate table 15. In ACT 158, the processor 111 calculates a tax inclusive price. The tax inclusive price is calculated by the following Expression (1).

Tax inclusive price=[Price+(price*tax rate)]*number of purchased articles (1)

In ACT 159, the processor 111 creates commodity details data of a purchase commodity. As explained above, the commodity details data is configured by a commodity code, a classification code, a commodity name, a price, a tax class, the number of purchased articles, and a tax inclusive price of the purchase commodity, the target flag Fa, the in-store flag Fb, the cancellation flag Fc, the update flag Fd, and the like. In the following explanation, the commodity details data created by the processing in ACT 159 is referred to as created commodity details data (first data).

In ACT 160, the processor 111 checks whether the tax class of the created commodity details data is “4”. In the case of created commodity details data of a purchase commodity, a tax class of which is “4”, that is, which is allowed to be eaten and drunk in the eat-in area, the processor 111 proceeds to ACT 161. In ACT 161, the processor 111 sets the target flag Fa of the created commodity details data to “1” and sets the in-store flag Fb and the cancellation flag Fc to “0”.

On the other hand, in the case of created commodity details data, a tax class of which is other than “4”, that is, which is not easily eaten and drunk in the eat-in area, the processor 111 proceeds to ACT 162. In ACT 162, the processor 111 sets all of the target flag Fa, the in-store flag Fb, and the cancellation flag Fc of the created commodity details data to “0”.

If finishing the processing in ACT 161 or ACT 162, the processor 111 proceeds to ACT 163. In ACT 163, the processor 111 sets the update flag Fd of the created commodity details data to “1”. In ACT 164, the processor 111 saves the created commodity details data in the transaction file 51. In ACT 165, the processor 111 updates a total number of articles, a total amount, and a price-cut total amount of the transaction file 51. Specifically, the processor 111 adds the number of purchased articles of the created commodity details data to the total number of articles and adds the tax inclusive price of the created commodity details data to the total amount.

If finishing the processing explained above, in ACT 166, the processor 111 transmits a details response command to the information terminal 40 at a registration notification command transmission source. The details response command includes the number of details data n saved in the transaction file 51, commodity details data of all of the number of details data n, the total number of articles, the total amount, and the price-cut total amount.

Referring back to FIG. 11, in ACT 23, the processor 41 that controlled the transmission of the registration notification command waits for the details response command. If receiving the details response command via the wireless unit 46, the processor 41 proceeds to ACT 24. Processing in ACT 24 and subsequent acts is explained below.

Subsequently, a case in which a barcode is not attached to a purchase commodity is explained. A part of commodities such as perishables includes a commodity to which a barcode is not attached. If a barcode is not attached to the purchase commodity, the customer touches the no-barcode button BTb.

If the no-barcode button BTb is touched in the waiting state in which the registration screen SCb is displayed on the touch panel 44, that is, the waiting state in ACT 8 and ACT 9 in FIG. 10, the processor 41 proceeds to ACT 27 in FIG. 11. If the no-barcode button BTb is touched in the waiting state in which the scan image SCc is displayed on the touch panel 44, that is, the waiting state in ACT 12 to ACT 14 in FIG. 10, the processor 41 proceeds to ACT 26 in FIG. 11, stops the camera 45, and, thereafter, proceeds to ACT 27. In ACT 27, the processor 41 causes the touch panel 44 to display a target list of no-barcode commodities. In ACT 28, the processor 41 waits for a purchase commodity to be selected.

The customer selects a purchase commodity out of the list. If the purchase commodity is selected, the processor 41 proceeds to ACT 22 explained above. That is, the processor 41 controls the wireless unit 46 to perform registration notification. According to the control, the wireless unit 46 wirelessly transmits a registration notification command. The registration notification command is received by the access point 27 and transmitted to the registration support server 11 via the router 26 of the POS system 20. A commodity code and a transaction identification code of the selected purchase commodity are included in the registration notification command.

In the registration support server 11 that receives the registration notification command, the registration notification processing explained with reference to FIG. 21 is executed. Therefore, in ACT 23, the processor 41 that controlled the transmission of the registration notification command waits for a details response command. If receiving the details response command via the wireless unit 46, the processor 41 proceeds to ACT 24.

As explained above, about a purchase commodity to which a barcode is attached, the information terminal 40 transmits, to the registration support server 11, the registration notification command including the barcode scanned by the camera 45, that is, the commodity code used to specify the purchase commodity and receives the details response command from the registration support server 11. About a purchase commodity to which a barcode is not attached, the information terminal 40 transmits, to the registration support server 11, the registration notification command including the commodity code used to specify the purchase commodity selected out of the target list of no-barcode commodities displayed on the touch panel 44 and receives the details response command from the registration support server 11.

The camera 45 and the touch panel 44 function as an input unit to which commodity data used to specify a purchase commodity, which is a transaction target commodity, is input.

The processor 41 that receives the details response command from the registration support server 11 proceeds to ACT 24. In ACT 24, the processor 41 executes details analysis processing.

FIG. 18 is a flowchart illustrating a specific processing procedure of the details analysis processing. If starting the details analysis processing, in ACT 101, the processor 41 sets, in a register memory M, the number of details data n included in the details response command. In ACT 102, the processor 41 sets an initial value of a first counter m to “0”. Subsequently, in ACT 103, the processor 41 counts up the first counter m by “1”. In ACT 104, the processor 41 checks whether the first counter m exceeds a value of the register memory M.

If the first counter m does not exceed the value of the register memory M, the processor 41 proceeds to ACT 105. In ACT 105, the processor 41 checks whether the update flag Fd of m-th (m is a count value of the first counter m) commodity details data included in the details response command is “1”. If the update flag Fd is “0”, the processor 41 returns to ACT 103. That is, the processor 41 further counts up the first counter m by “1”. If confirming that the first counter m does not exceed the value of the register memory M, the processor 41 checks whether the update flag Fd of the m-th commodity details data is “1”.

If the update flag Fd of the m-th commodity details data is “1”, the processor 41 proceeds to ACT 106. In ACT 106, the processor 41 checks whether other commodity details data, a commodity code, a classification code, a commodity name, and a price of which coincide with those of the m-th commodity details data, is stored in the list memory 61. If the relevant other commodity details data is not stored in the list memory 61, the processor 41 proceeds to ACT 107. In ACT 107, the processor 41 adds the m-th commodity details data to the list memory 61. In the following explanation, the commodity details data added to the list memory 61 is referred to as added commodity details data (second data).

The list memory 61 functions as a storing unit that stores commodity details data including a commodity name, a price, and a tax rate of a purchase commodity, which is a transaction target commodity specified by commodity data.

If the relevant other commodity details data is stored in the list memory 61 in ACT 106, the processor 41 proceeds to ACT 108. In ACT 108, the processor 41 updates a tax rate, the number of purchased articles, a tax inclusive price, the in-store flag Fb, and the cancellation flag Fc of the relevant other commodity details data to coincide with the m-th commodity details data. In the following explanation, the commodity details data updated on the list memory 61 is referred to as updated commodity details data (third data).

If finishing the processing in ACT 107 or ACT 108, the processor 41 proceeds to ACT 109. In ACT 109, the processor 41 checks the target flag Fa of the added commodity details data or the updated commodity details data. If the target flag Fa is “0”, the processor 41 proceeds to ACT 110. In ACT 110, the processor 41 sets the tag segment stored in the list memory 61 in correlation with the added commodity details data or the updated commodity details data to “0”.

If the target flag Fa of the added commodity details data or the updated commodity details data is “1”, the processor 41 proceeds to ACT 111. In ACT 111, the processor 41 acquires the in-store flag Fb and the cancellation flag Fc of the added commodity details data or the updated commodity details data. In ACT 112, the processor 41 searches through the tag table 63 with the target flag Fa (Fa=1), the in-store flag Fb (Fb=0 or 1), and the cancellation flag Fc (Fc=0 or 1) of the added commodity details data or the updated commodity details data. In ACT 113, the processor 41 detects, from the tag table 63, tag segments “1” to “3” associated with the target flag Fa, the in-store flag Fb, and the cancellation flag Fc and sets the tag segments “1” to “3” as tag segments stored in the list memory 61 in correlation with the added commodity details data or the updated commodity details data.

If finishing the processing in ACT 110 or ACT 113, the processor 41 returns to ACT 103. The processor 41 executes the processing in ACT 103 and subsequent acts in the same manner as explained above.

If the first counter m exceeds the value of the register memory M in ACT 104, the processor 41 proceeds to ACT 114. In ACT 114, the processor 41 stores the total number of articles, the total amount, and the price-cut total amount included in the details response command respectively in the areas of the total number of articles Ta, the total amount Tb, and the price-cut total amount Tc of the total memory 62. Then, the processor 41 ends the details analysis processing.

Therefore, the tag segments are set for the commodity details data stored in the list memory 61. Specifically, the tag segment “0” is set for the commodity details data, the target flag Fa of which is “0”. The tag segment “1” is set for the commodity details data, the target flag Fa of which is “1” and the in-store flag Fb and the cancellation flag Fc of which is “0”. The tag segment “2” is set for the commodity details data, the target flag Fa and the in-store flag Fb of which is “1” and the cancellation flag Fc is “0”. The tag segment “3” is set for the commodity details data, all of the target flag Fa, the in-store flag Fb, and the cancellation flag Fc of which are “1”.

Referring back to FIG. 11, if finishing the details analysis processing, the processor 41 proceeds to ACT 25. In ACT 25, the processor 41 executes registration screen editing processing.

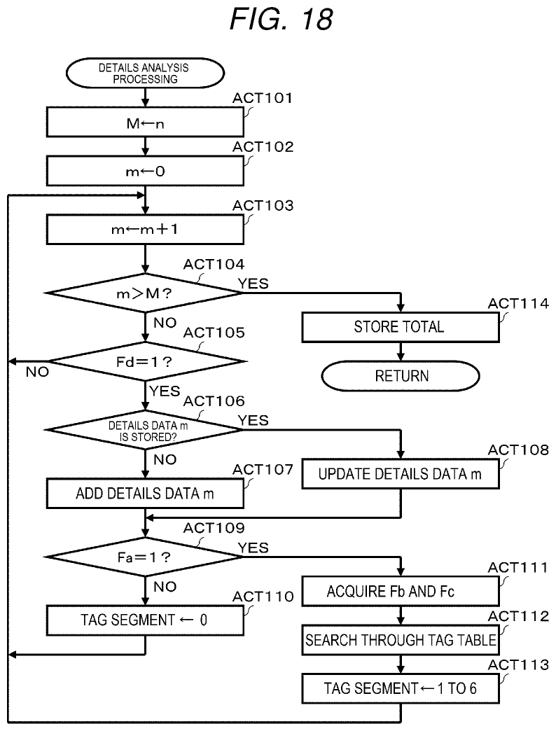

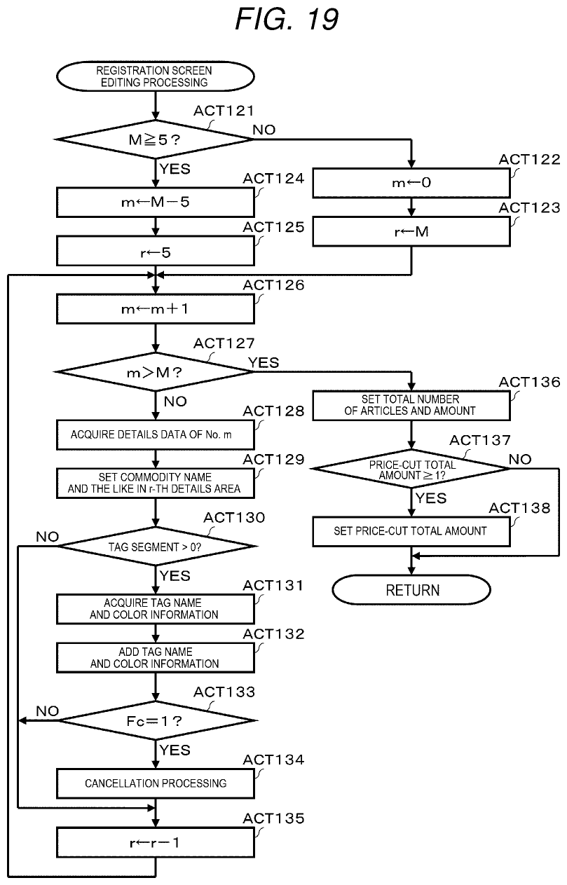

FIG. 19 is a flowchart illustrating a specific processing procedure of the registration screen editing processing. If starting the registration screen editing processing, in ACT 121, the processor 41 checks whether the value of the register memory M is “5” or larger. “5” is the largest number of articles that can be displayed on the details list display section ARb of the registration screen. If the value of the register memory M is smaller than “5”, the processor 41 proceeds to ACT 122. In ACT 122, the processor 41 sets the initial value of the first counter m to “0”. In ACT 123, the processor 41 sets an initial value of a second counter r to the value of the register memory M.

In ACT 121, if the value of the register memory M is “5” or larger, the processor 41 proceeds to ACT 124. In ACT 124, the processor 41 sets the initial value of the first counter m to a value obtained by subtracting “5” from the value of the register memory M. In ACT 125, the processor 41 sets the initial value of the second counter r to “5”.

If finishing the processing in ACT 123 or ACT 125, the processor 41 proceeds to ACT 126. In ACT 126, the processor 41 counts up the first counter m by “1”. In ACT 127, the processor 41 checks whether the first counter m exceeds the value of the register memory M.

If the first counter m does not exceed the value of the register memory M, the processor 41 proceeds to ACT 128. In ACT 128, the processor 41 acquires the commodity details data, the list number of which is “m”, from the list memory 61. In the following explanation, the commodity details data acquired from the list memory 61 is referred to as acquired commodity details data (fourth data).

In ACT 129, the processor 41 sets a commodity name, the number of purchased articles, a tax rate, and a tax inclusive price in an editing buffer of the registration screen such that the commodity name, the number of purchased articles, the tax rate, and the tax inclusive price of the acquired commodity details data are displayed in an r-th details area from the bottom of the details list display section ARb. The editing buffer is a part of the built-in memory 42. In ACT 129, the processor 41 may set the commodity name, the number of purchased articles, the tax rate, and the tax inclusive price in the editing buffer of the registration screen to be displayed in an r-th details area from the top of the details list display section ARb.

In ACT 130, the processor 41 checks a tag segment stored in the list memory 61 in correlation with the acquired commodity details data. If the tag segment is other than “0”, the processor 41 proceeds to ACT 131. In ACT 131, the processor 41 searches through the tag table 63 and acquires a tag name and color information correlated with the tag segment. In ACT 132, the processor 41 adds the tag name and the color information to information of the commodity name, the number of purchased articles, the tax rate, and the tax inclusive price set in the editing buffer in ACT 129.

In ACT 133, the processor 41 checks whether the cancellation flag Fc of the acquired commodity details data is “1”. If the cancellation flag Fc is “1”, in ACT 134, the processor 41 executes cancellation processing on the information of the commodity name, the number of purchased article, the tax rate, and the tax inclusive price set in the editing buffer in ACT 129. Details of the cancellation processing are explained below. If the cancellation flag Fc is “0” in ACT 133, the processor 41 skips the processing in ACT 134. Thereafter, the processor 41 proceeds to ACT 135.

On the other hand, if the tag segment is “0” in ACT 130, the processor 41 skips the processing in ACT 131 to ACT 134. The processor 41 proceeds to ACT 135. That is, if the tag segment is “0”, the processor 41 does not add the tag name and the color information to the editing buffer and does not perform the cancellation processing.

In ACT 135, the processor 41 counts down the second counter r by “1”. The processor 41 returns to ACT 126. The processor 41 executes the processing in ACT 126 and subsequent acts in the same manner as explained above. Therefore, the processor 41 repeats processing for sequentially acquiring m-th and subsequent commodity details data from the list memory 61 and setting, in the editing buffer, information of commodity names, prices, tax rates, and the numbers of purchased articles of the acquired commodity details data. At that time, if a tag segment other than “0” is stored in the list memory 61 in correlation with the acquired commodity details data, the processor 41 adds a tag name and color information set in the tag table 63 in association with the tag segment to the editing buffer.

That is, about the acquired commodity details data for which the tag segment “1” is stored in the list memory 61, a tag name “eat-in target” and color information of black are added. About the acquired commodity details data for which the tag segment “2” is stored in the list memory 61, a tag name “eat-in” and color information of red are added. About the acquired commodity details data for which the tag segment “3” is stored in the list memory 61, a tag name “eat-in cancellation” and color information of green are added. The cancellation processing is executed on the information of the commodity name, the number of purchased articles, the tax rate, and the tax inclusive price of the acquired commodity details data to which the tag name “eat-in cancellation” is added. For example, processing for displaying cancellation lines on the commodity name and the tax inclusive price is executed.

In ACT 127, if the first counter m exceeds the value of the register memory M, the processor 41 proceeds to ACT 136. In ACT 136, the processor 41 sets the total number of articles and the total amount of the total memory 62 in the editing buffer such that the total number of articles and the total amount are displayed in the total display section ARa. In ACT 137, the processor 41 checks whether the price-cut total amount is 1 yen or more. If the price-cut total amount is 1 yen or more, in ACT 138, the processor 41 sets the price-cut total amount in the editing buffer such that the price-cut total amount is displayed in the total display section ARa. If the price-cut total amount is 0 yen, the processor 41 skips the processing in ACT 138. Then, the processor 41 ends the registration screen editing processing.

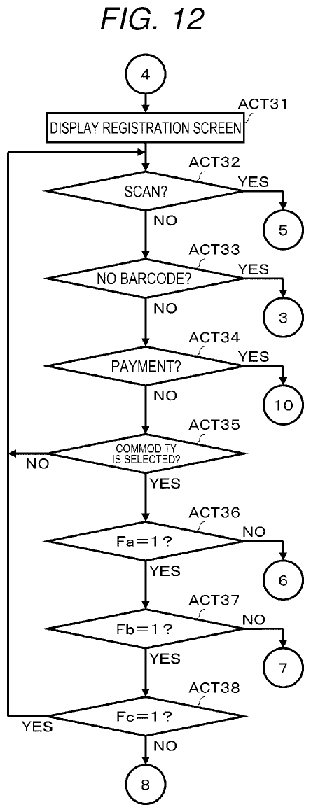

Referring back to FIG. 11, if finishing the registration screen editing processing, the processor 41 proceeds to ACT 31 in FIG. 12. In ACT 31, the processor 41 switches the screen of the touch panel 44 from the scan screen SCc or the screen of the target list of no-barcode commodities to a registration screen SCd (see FIG. 31).

FIG. 31 is an example of the registration screen SCd at the time when commodity details data of a purchase commodity “alcoholic beverage “X” of a first item is stored in the list memory 61 as a transaction target commodity. The purchase commodity “alcoholic beverage X” is a commodity, the tax class of which is “2”, that is, on which the standard tax rate is imposed. Therefore, as illustrated in FIG. 31, a commodity name, the number of purchased articles, a tax rate, and a tax inclusive price of the purchase commodity “alcoholic beverage X” are displayed in a details area at the top of the details list display section ARb. The tax rate is the standard tax rate “10%”. A tag is not displayed. The total number of articles “1” and the total amount “220 yen (¥220)” are displayed in the total display section ARa.

The processor 41 that changed the screen of the touch panel 44 to the registration screen SCd waits for the scan button BTa to be touched in ACT 32, the no-barcode button BTb to be touched in ACT 33, the payment button BTc to be touched in ACT 34, or any one of purchase commodities displayed in the details list display section ARb to be selected in ACT 35.

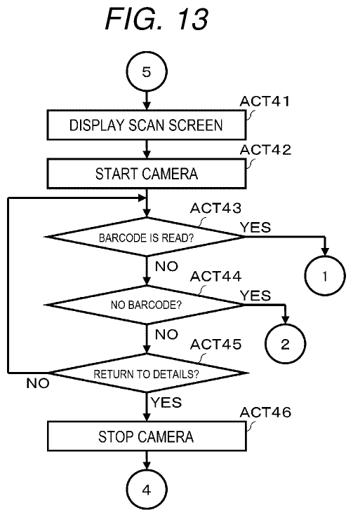

If the scan button BTa is touched in the waiting state in ACT 32 to ACT 35, the processor 41 proceeds to ACT 41 in FIG. 13. In ACT 41, the processor 41 switches the screen of the touch panel 44 from the registration screen SCd to the scan screen SCc (see FIG. 30). In ACT 42, the processor 41 starts the camera 45. Thereafter, the processor 41 waits for a barcode to be read in ACT 43, the no-barcode button BTb to be touched in ACT 44, or the return-to-details button BTd to be touched in ACT 45.

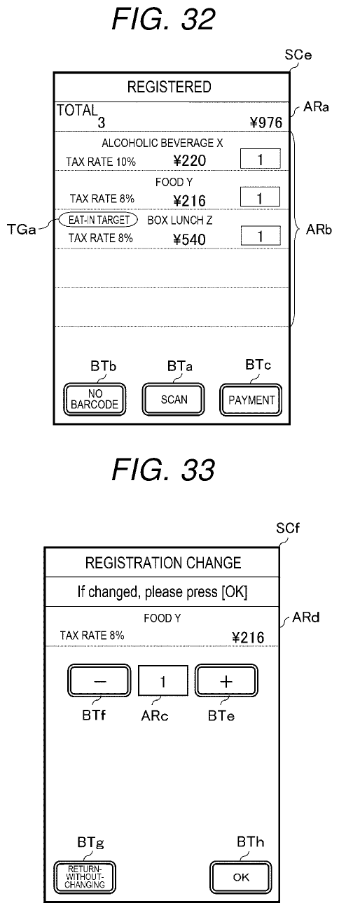

If a barcode is read in the waiting state in ACT 43 to ACT 45, the processor 41 proceeds to ACT 21 in FIG. 11. The processor 41 executes the processing in ACT 21 and subsequent acts in the same manner as explained above. If the no-barcode button BTb is touched, the processor 41 proceeds to ACT 26 in FIG. 11. The processor 41 executes the processing in ACT 26 and subsequent acts in the same manner as explained above. That is, the processor 41 transmits a registration notification command including a commodity code of the purchase commodity to the registration support server 11. If receiving a details response command from the registration support server 11, the processor 41 executes the details analysis processing and the registration screen editing processing and changes the screen of the touch panel 44 to a registration screen SCe (see FIG. 32).

If the return-to-details button BTd is touched in the waiting state in ACT 43 to ACT 45, the processor 41 proceeds to ACT 46. In ACT 46, the processor 41 stops the camera 45. The processor 41 returns to ACT 31 in FIG. 12. The processor 41 returns the screen of the touch panel 44 from the scan screen SCc to the immediately preceding registration screen SCd.

FIG. 32 is an example of the registration screen SCe at the time when commodity details data of a purchase commodity “food Y” of a second item and commodity details data of a purchase commodity “box lunch Z” of a third item are stored in the list memory 61 as purchase target commodities. The purchase commodity “food Y” is a food and a beverage un-adapted to eat-in, a tax class of which is “3”, that is, on which the reduced tax rate is imposed. Therefore, as illustrated in FIG. 32, a commodity name, the number of purchased articles, a tax rate, and a tax inclusive price of the purchase commodity “food Y” are displayed in a second details area from the top of the details list display section ARb. The tax rate is the reduced tax rate of “8%”. A tag is not displayed. The purchase commodity “box lunch Z” is a food and a beverage adapted to eat-in, a tax class of which is “4”, that is, on which the reduced tax rate is imposed. A tag TGa with a tag name “eat-in target” is displayed in black characters together with a commodity name, the number of purchased articles, a tax rate, and a tax inclusive price of the purchase commodity “box lunch Z” in a third details area from the top of the details list display section ARb. The tax rate is the reduced tax rate of “8%”.

A total number of articles “3” and a total amount “976 yen (¥976)” are displayed in the total display section ARa of the registration screen SCe.

The touch panel 44 that displays the registration screen functions as a display unit that displays commodity details data including a tax rate of a tax imposed on a purchase commodity specified by commodity data input via the input unit. The processor 41 that causes the touch panel 44 to display the registration screen functions as display means.

Since the tag TGa with the tag name “eat-in target” is displayed for the purchase commodity “box lunch Z”, the customer who checks the registration screen SCe can identify that the purchase commodity “box lunch Z” is a commodity that is allowed to be eaten and drunk in the eat-in area. Since the tag TGa is not displayed for the purchase commodities “alcoholic beverage X” and “food Y”, the customer can identify that the purchase commodities “alcoholic beverage X” and “food Y” are commodities that are not allowed to be eaten and drunk in the eat-in area.

In the information terminal 40, the customer is capable of changing the number of purchased articles, declaring eat-in, or cancelling the eat-in declaration by performing selection operation for a purchase commodity displayed in the details list display section ARb of the registration screen SCe. The selection operation is, for example, tap operation, flick operation, or swipe operation for an area where a commodity name and the like are displayed. The selection operation may be other operation.

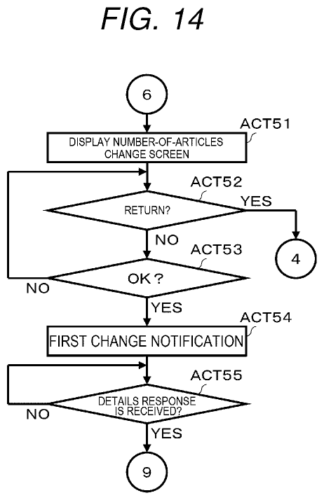

If the selection operation is performed for any one of the purchase commodities displayed in the details list display section ARb in the waiting state in ACT 32 to ACT 35, the processor 41 proceeds to ACT 36. The processor 41 checks the target flag Fa included in commodity details data of the purchase commodity for which the selection operation is performed in ACT 36. If a purchase commodity, the target flag Fa of which is “0”, that is, which is not an eat-in target, is selected, the processor 41 proceeds to ACT 51 in FIG. 14. In ACT 51, the processor 41 switches the screen of the touch panel 44 from the registration screen SCe to a number-of-articles change screen SCf (see FIG. 33).

FIG. 33 is an example of the number-of-articles change screen SCf in the case in which the purchase commodity “food Y”, the target flag Fa of which is “0”, is selected. As illustrated, a number-of-purchased-articles display section ARc and a details display section ARd are disposed on the number-of-articles change screen SCf. The number of purchased articles of a selected purchase commodity is displayed in the number-of-purchased-articles display section ARc and a commodity name, a tax rate, a tax inclusive price, and the like of the purchase commodity are displayed in the details display section ARd. On the number-of-articles change screen SCf, an addition button BTe is disposed on one side across the number-of-purchased-articles display section ARc and a subtraction button BTf is disposed on the other side. Further, a return-without-changing button BTg and an OK button BTh are disposed on the number-of-articles change screen SCf.

The customer who checked the number-of-articles change screen SCf touches the addition button BTe or the subtraction button BTf and changes the number of purchased articles displayed in the number-of-purchased-articles display section ARc. For example, if the number of purchased articles of the purchase commodity “food Y” is changed to five, the customer touches the addition button BTe four times and sets the number of purchased articles of the number-of-purchased-articles display section ARc to “5”. Incidentally, to cancel the purchase of the purchase commodity “food Y”, the customer only has to touch the subtraction button BTf once and set the number of purchased articles of the number-of-purchased-articles display section ARc to “0”. If finishing changing the number of articles, the customer touches the OK button BTh. To cancel changing the number of articles, the customer touches the return-without-changing button BTg.

Referring back to FIG. 14, the processor 41 that controlled the display of the number-of-articles change screen SCf waits for the return-without-changing button BTg to be touched in ACT 52 or the OK button BTh to be touched in ACT 53. If the return-without-changing button BTg is touched in the waiting state in ACT 52 and ACT 53, the processor 41 returns to ACT 31 in FIG. 12. That is, the processor 41 returns the screen of the touch panel 44 to the immediately preceding registration screen SCe.

If the OK button BTh is touched in the waiting state of ACT 52 and ACT 53, in ACT 54, the processor 41 controls the wireless unit 46 to perform first change notification. According to this control, the wireless unit 46 wirelessly transmits a first change notification command. The first change notification command is received by the access point 27 and transmitted to the registration support server 11 via the router 26 of the POS system 20. The number of articles in the number-of-purchased-articles display section ARc, that is, the number of purchased articles after change is included in the first change notification command together with a commodity code of a change target commodity. The transaction identification code stored in the information terminal 40 is also included in the first change notification command.

First change notification processing is executed in the registration support server 11 that receives the first change notification command.

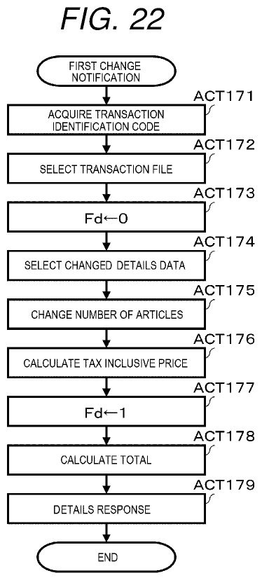

FIG. 22 is a flowchart illustrating a main part procedure of the first change notification processing. If receiving the first change notification command via the communication interface 115, in ACT 171, the processor 111 of the registration support server 11 acquires the transaction identification code from the first change notification command. In ACT 172, the processor 111 selects the transaction file 51 in which the transaction identification code is saved.

In ACT 173, the processor 111 sets all of the update flags Fd of the commodity details data stored in the transaction file 51 to “0”. Subsequently, in ACT 174, the processor 111 selects commodity details data of the commodity code included in the first change notification command out of the commodity details data stored in the transaction file 51. In ACT 175, the processor 111 changes the number of purchased articles of the commodity details data to the number of purchased articles included in the first change notification command. In the following explanation, the commodity details data, the number of purchased articles of which is changed, is referred to as number-of-articles changed commodity details data (fifth data).

In ACT 176, the processor 111 calculates a tax inclusive price based on the price, the tax rate, and the number of purchased articles after change of the number-of-articles changed commodity details data. In ACT 177, the processor 111 sets the update flag Fd of the number-of-articles changed commodity details data to “1”. In ACT 178, the processor 111 recalculates the total number of articles, the total amount, and the price-cut total amount of the transaction file 51. If finishing the processing explained above, in ACT 179, the processor 111 transmits a details response command to the information terminal 40 at a first change notification command transmission source.

As explained above, the number of purchased articles included in the commodity details data of the purchase commodity is changed by the first change notification processing executed in the registration support server 11. The tax inclusive price of the commodity details data is changed and the update flag Fd is changed from “0” to “1”.

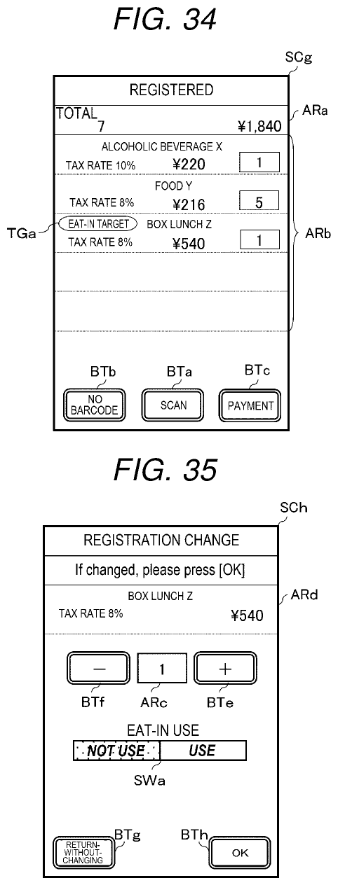

Referring back to FIG. 14, in ACT 55, the processor 41 that controlled the transmission of the first change notification command waits for a details response command. If receiving the details response command via the wireless unit 46, the processor 41 proceeds to ACT 24 in FIG. 11. In ACT 24, the processor 41 executes the details analysis processing. Subsequently, in ACT 25, the processor 41 executes the registration screen editing processing. In ACT 31, the processor 41 switches the screen of the touch panel 44 to a registration screen SCg (see FIG. 34) and returns to the waiting state in ACT 32 to ACT 35.

FIG. 34 is an example of the registration screen SCg in the case in which the number of purchased articles of the purchase commodity “food Y” is changed from “1” to “5” on the registration screen SCe illustrated in FIG. 32. As illustrated, the number of purchased articles of the purchase commodity “food Y” is “5”. The total number of articles of the total display section ARa is “7” and the total amount of the total display section ARa is “1840 yen (¥1,840)”.

As explained above, about the purchase commodity that is not the eat-in target, the number of purchased articles can be changed to “2” or more or “0” by using the number-of-articles change screen SCf. The number-of-articles change screen SCf may not be used to change the number of purchased articles. For example, the number of purchased articles displayed in the details list display section ARb of the registration screen may be displayed in a cell of a pulldown list. The number of purchased articles after change may be selected out of the pulldown list. Alternatively, a screen of ten keys may be displayed. The number of purchased articles after change may be numerically input.

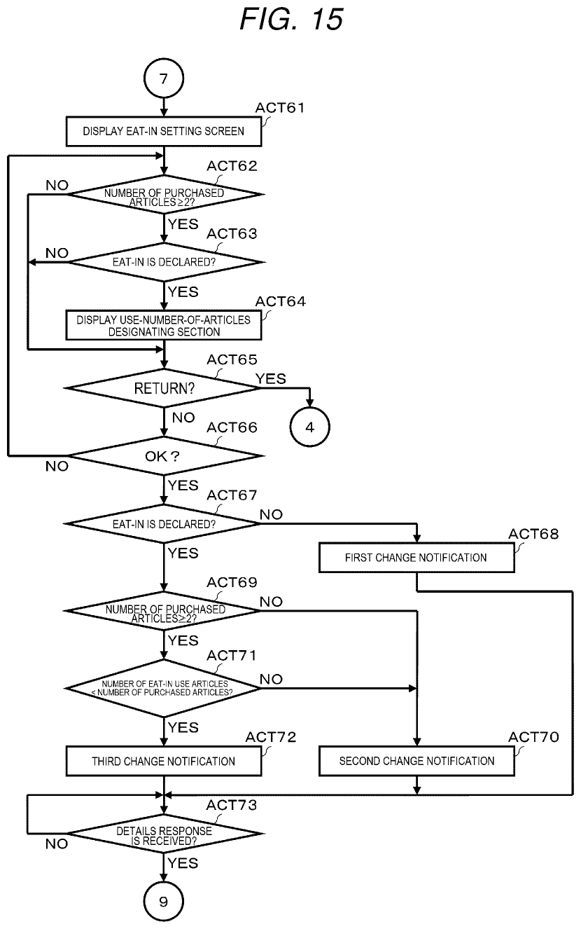

Referring back to FIG. 12, if a purchase commodity, the target flag Fa of which included in the commodity details data of the selected purchase commodity is “1”, that is, which is allowed to be eaten and drunk in the eat-in area is selected, the processor 41 proceeds to ACT 37. In ACT 37, the processor 41 checks the in-store flag Fb included in the commodity details data. If the in-store flag Fb is “0”, that is, the eat-in declaration is not performed for the purchase commodity, the processor 41 proceeds to ACT 61 in FIG. 15. In ACT 61, the processor 41 switches the screen of the touch panel 44 from the registration screen SCe to an eat-in setting screen SCh (see FIG. 35).

FIG. 35 is an example of the eat-in setting screen SCh in the case in which the purchase commodity “box lunch Z”, the target flag Fa of which is “1” and the in-store flag Fb of which is “0”, is selected in FIG. 32. As illustrated, a switch SWa for instructing switching from “not use eat-in” to “use eat-in” is disposed on the eat-in setting screen SCh. The number-of-purchased-articles display section ARc and the details display section ARd are disposed on the eat-in setting screen SCh as on the number-of-articles change screen SCf. The number of purchased articles of the selected purchase commodity is displayed in the number-of-purchased-articles display section ARc. A commodity name, a tax rate, a tax inclusive price, and the like of the purchase commodity are displayed in the details display section ARd. The addition button BTe is disposed on one side across the number-of-purchased-articles display section ARc, the subtraction button BTf is disposed on the other side, and the return-without-changing button BTg and the OK button BTh are further disposed on the eat-in setting screen SCh as on the number-of-articles change screen SCf.

If the customer who checked the eat-in setting screen SCh eats and drinks the purchase commodity “box lunch Z” in the eat-in area, the customer switches the switch SWa from “not use eat-in” to “use eat-in”. The customer touches the OK button BTh.

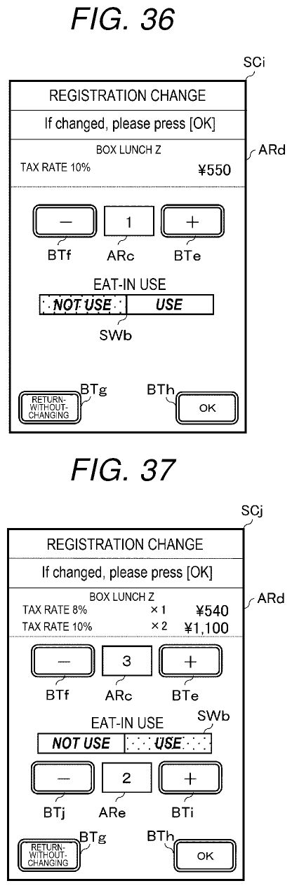

FIG. 36 is an example of an eat-in setting screen SCi in the case in which the switch SWa is switched from “not use eat-in” to “use eat-in” in FIG. 35. As illustrated, on the eat-in setting screen SCi, the switch SWa is a switch SWb for instructing switching from “use eat-in” to “not use eat-in”. The tax rate displayed in the details display section ARd changes from “8%” of the reduced tax rate to “10%” of the standard tax rate. The tax inclusive price displayed in the details display section ARd changes from “540 yen (¥540)” to “550 yen (¥550)”.

For example, it is also assumed that the customer purchases three articles of the purchase commodity “box lunch Z”, eats and drinks two articles among the three articles in the eat-in area and takes out the remaining one article. In such a case, the customer touches the addition button BTe two times and changes the number of purchased articles of the number-of-purchased articles display section ARc to “3”. The customer switches the switch SWa from “not use eat-in” to “use eat-in”.

FIG. 37 is an example of an eat-in setting screen SCj at the time when the number of purchased articles of the number-of-purchased-articles display section ARc is changed to “3” and the switch SWa is switched from “not use eat-in” to “use eat-in”. As illustrated, on the eat-in setting screen SCj, the switch SWa changes to the switch SWb for instructing switching from “use eat-in” to “not use eat-in”. An eat-in-number-of-articles display section ARe is disposed below the switch SWb. An addition button BTi and a subtraction button BTj are displayed across the eat-in-number-of-articles display section ARe. In the beginning, the number of articles “3” of the number-of-purchased-articles display section ARc is displayed in the eat-in-number-of-articles display section ARe. The eat-in-number-of-articles display section ARe, the addition button BTi, and the subtraction button BTj explained above function as a used-number-of-articles designating section.

The customer who checked the eat-in setting screen SCj touches the subtraction button BTj once and sets the number of eat-in use articles of the eat-in-number-of-articles display section ARe to “2”. The customer touches the OK button BTh. According to the operation explained above, as illustrated in FIG. 37, together with the reduced tax rate “8%”, the number of purchased articles “1 (×1)” taxed at the tax rate and a tax inclusive price “540 yen (¥540)” are displayed in the details display section ARd of the eat-in setting screen SCj. Together with the standard tax rate “10%”, the number of purchased articles “2 (×2)” taxed at the tax rate and a tax inclusive price “1100 yen (¥1,100)” are displayed.

If the customer who checked the eat-in setting screen SCh, SCi, or SCj cancels the eat-in declaration, the customer touches the return-without-changing button BTg.

The processor 41 that causes the touch panel 44 to display the eat-in setting screen including the switch SWa and receives a switching input for the switch SW functions as a receiving unit that receives a tax rate changing instruction for a tax imposed on a purchase commodity, commodity details data of which is displayed on the display unit. The receiving unit can be referred to as receiving means as well.

Referring back to FIG. 15, in ACT 62, the processor 41 that controlled the display of the eat-in setting screen SCh checks whether the number of purchased articles displayed in the number-of-purchased-articles display section ARc is changed to “2” or more. If the number of purchased articles is not changed to “2” or more, the processor 41 proceeds to ACT 65.

If the number of purchased articles is changed to “2” or more in ACT 62, the processor 41 proceeds to ACT 63. In ACT 63, the processor 41 checks whether the switch SWa is switched from “not use eat-in” to “use eat-in”. If the switch SWa is not switched, the processor 41 proceeds to ACT 65.

If the switch SWa is switched from “not use eat-in” to “use eat-in” in ACT 63, the processor 41 proceeds to ACT 64. In ACT 64, the processor 41 causes the touch panel 44 to display, on the eat-in setting screen, the used-number-of-articles designating section including the eat-in-number-of-articles display section ARe, the addition button BTi, and the subtraction button BTj. Thereafter, the processor 41 proceeds to ACT 65.

The processor 41 waits for the return-without-changing button BTg to be touched in ACT 65 or the OK button BTh to be touched in ACT 66. If the return-without-changing button BTg is touched in the waiting state in ACT 65 and ACT 66, the processor 41 returns to ACT 31 in FIG. 12. That is, the processor 41 returns the screen of the touch panel 44 to the immediately preceding registration screen SCe.

If the OK button BTh is touched in the waiting state in ACT 65 and ACT 66, in ACT 67, the processor 41 checks whether the switch SWa is switched from “not use eat-in” to “use eat-in”. If the switch SWa is not switched, the processor 41 proceeds to ACT 68. In ACT 68, the processor 41 controls the wireless unit 46 to perform first change notification. According to the control, the wireless unit 46 wirelessly transmits a first change notification command. The first change notification command is received by the access point 27 and transmitted to the registration support server 11 via the router 26 of the POS system 20. The number of articles in the number-of-purchased-articles display section ARc, that is, the number of purchased articles after change is included in the first change notification command together with the commodity code of the change target commodity. The transaction identification code stored in the information terminal 40 is also included in the first change notification command.

In the registration support server 11 that receives the first change notification command, the first change notification processing explained above with reference to FIG. 22 is executed. Therefore, about an eat-in target purchase commodity, the number of purchased articles can be changed to “2” or more or “0” by using the eat-in setting screen SCh.

If the switch SWa is switched from “not use eat-in” to “use eat-in” in ACT 67, the processor 41 proceeds to ACT 69. In ACT 69, the processor 41 checks whether the number of purchased articles displayed in the number-of-purchased-articles display section ARc is “2” or more. If the number of purchased articles is “1”, the processor 41 proceeds to ACT 70. In ACT 70, the processor 41 controls the wireless unit 46 to perform second change notification. According to the control, the wireless unit 46 wirelessly transmits a second change notification command. The second change notification command is received by the access point 27 and transmitted to the registration support server 11 via the router 26 of the POS system 20. The number of purchased articles in the number-of-purchased articles display section ARc is included in the second change notification command together with the commodity code of the change target commodity. The transaction identification code stored in the information terminal 40 is also included in the second change notification command.

In the registration support server 11 that receives the second change notification command, second change notification processing is executed. The second change notification processing is explained below.

If the number of purchased articles is “2” or more in ACT 69, the processor 41 proceeds to ACT 71. In ACT 71, the processor 41 compares the number of purchased articles displayed in the number-of-purchased-articles display section ARc and the number of eat-in use articles displayed in the eat-in-number-of-articles display section ARe. As a result, if the number of purchased articles and the number of eat-in use articles are equal, that is, the eat-in declaration is performed for all of the two or more articles of the purchase commodity, the processor 41 proceeds to ACT 70 explained above. That is, the processor 41 controls the wireless unit 46 to transmit, to the registration support server 11, the second change notification command including the commodity code of the commodity for which the eat-in declaration is performed, the number of purchased articles, and the transaction identification code.

If the number of eat-in use articles is smaller than the number of purchased articles in ACT 71, that is, if the eat-in declaration is performed for a part of the two or more articles of the purchase commodity, the processor 41 proceeds to ACT 72. In ACT 72, the processor 41 controls the wireless unit 46 to perform third change notification. According to the control, the wireless unit 46 wirelessly transmits a third change notification command. The third change notification command is received by the access point 27 and transmitted to the registration support server 11 via the router 26 of the POS system 20. The commodity code of the commodity for which the eat-in declaration is performed, the number of eat-in use articles, and the transaction identification code are included in the third change notification command. The third change notification command may include the number of articles obtained by subtracting the number of eat-in use articles from the number of purchased articles, that is, the number of eat-in nonuse articles.

In the registration support server 11 that receives the third change notification command, third change notification processing is executed. The third change notification processing is also explained below.

The processor 41 that controls the transmission of the second change notification command or the third change notification command functions as an output unit that outputs commodity data used to specify the purchase commodity for which the tax rate change instruction is received by the receiving unit. The output unit can be referred to as output means as well.

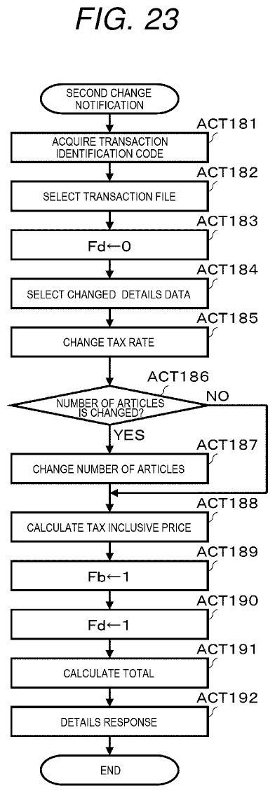

FIG. 23 is a flowchart illustrating a main part procedure of the second change notification processing. If receiving the second change notification command via the communication interface 115, in ACT 181, the processor 111 of the registration support server 11 acquires the transaction identification code from the second change notification command. In ACT 182, the processor 111 selects the transaction file 51 in which the transaction identification code is saved.

In ACT 183, the processor 111 sets all of the update flags Fd of the commodity details data stored in the transaction file 51 to “0”. Subsequently, in ACT 184, the processor 111 selects commodity details data of the commodity code included in the second change notification command out of the commodity details data stored in the transaction file 51. In ACT 185, the processor 111 changes a tax rate of the commodity details data from the reduced tax rate of 8% to the standard tax rate of 10%. In the following explanation, the commodity details data, the tax rate of which is changed, is referred to as tax rate changed commodity details data (sixth data).

In ACT 186, the processor 111 checks whether the number of purchased articles included in the second change notification command is changed with respect to the number of purchased articles of the tax rate changed commodity details data. If the number of purchased articles is changed, the processor 111 proceeds to ACT 187. In ACT 187, the processor 111 changes the number of purchased articles of the tax rate changed commodity details data to the number of purchased articles included in the change notification command. The processor 111 proceeds to ACT 188.

If the number of purchased articles is not changed in ACT 186, the processor 111 skips the processing in ACT 187. The processor 111 proceeds to ACT 188.

In ACT 188, the processor 111 calculates a tax inclusive price based on the price, the tax rate, and the number of purchased articles after change of the tax rate changed commodity details data. In ACT 189, the processor 111 sets the in-store flag Fb of the tax rate changed commodity details data to “1”. In ACT 190, the processor 111 sets the update flag Fd of the tax rate changed commodity details data to “1”. Further, in ACT 191, the processor 111 recalculates the total number of articles, the total amount, and the price-cut total amount of the transaction file 51. If finishing the processing explained above, in ACT 192, the processor 111 transmits a details response command to the information terminal 40 at a second change notification command transmission source.

The commodity details data of the purchase commodity for which the eat-in declaration is performed is updated as following by the second change notification processing executed in the registration support server 11 as explained above. That is, the tax rate is changed from the reduced tax rate to the standard tax rate. The tax inclusive price is changed from a tax inclusive price of the reduced tax rate to a tax inclusive price of the standard tax rate. Both of the in-store flag Fb and the update flag Fd are changed from “0” to “1”. If the number of purchased articles included in the second change notification command is changed with respect to the number of purchased articles of the tax rate changed commodity details data, the number of purchased articles is also changed.

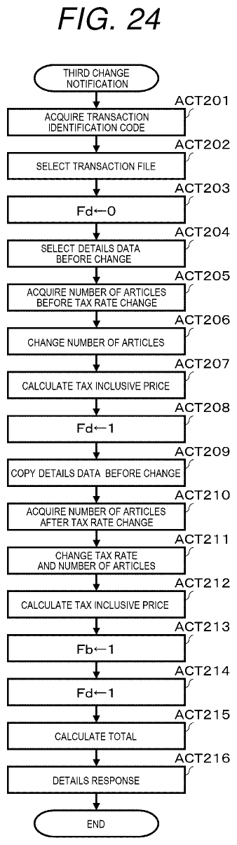

FIG. 24 is a flowchart illustrating a main part procedure of the third change notification processing. If receiving the third change notification command via the communication interface 115, in ACT 201, the processor 111 of the registration support server 11 acquires the transaction identification code from the third change notification command. In ACT 202, the processor 111 selects the transaction file 51 in which the transaction identification code is saved.

In ACT 203, the processor 111 sets all of the update flags Fd of the commodity details data stored in the transaction file 51 to “0”. Subsequently, in ACT 204, the processor 111 selects commodity details data of the commodity code included in the third change notification command out of the commodity details data stored in the transaction file 51. In the following explanation, the selected commodity details data is referred to as commodity details data before change (seventh data).

In ACT 205, the processor 111 acquires, as the number of purchased articles before a tax rate change, the number of articles obtained by subtracting the number of eat-in use articles included in the third change notification command from the number of purchased articles of the commodity details data before change. If an eat-in non-use number of articles is included in the third change notification command, in ACT 205, the processor 111 acquires the eat-in non-use number of articles. In ACT 206, the processor 111 changes the number of purchased articles of the commodity details data before change to the number of purchased articles before the tax rate change (the eat-in non-use number of articles). In ACT 207, the processor 111 calculates a tax inclusive price based on a price, a tax rate, and the number of purchased articles before the tax rate change of the commodity details data before change. In ACT 208, the processor 111 sets the update flag Fd of the commodity details data before change to “1”.

Subsequently, in ACT 209, the processor 111 copies the commodity details data before change on the list memory 61. In the following explanation, the copied commodity details data before change is referred to as commodity details data after change (eighth data). In ACT 210, the processor 111 acquires, as the number of purchased articles after the tax rate change, the number of eat-in use articles included in the third change notification command. In ACT 211, the processor 111 changes a tax rate of the commodity details data after change to the standard tax rate of 10% and changes the number of purchased articles to the number of purchased articles after the tax rate change.

In ACT 212, the processor 111 calculates a tax inclusive price based on a price, a tax rate, and the number of purchased articles after the tax rate change of the commodity details data after change. In ACT 213, the processor 111 sets the in-store flag Fb of the commodity details data after change to “1”. In ACT 214, the processor 111 sets the update flag Fd of the commodity details data after change to “1”.

Thereafter, in ACT 215, the processor 111 recalculates the total number of articles, the total amount, and the price-cut total amount of the transaction file 51. If finishing the processing explained above, in ACT 216, the processor 111 transmits a details response command to the information terminal 40 at a third change notification command transmission source.

The commodity details data of the purchase commodity for which the eat-in declaration is performed is updated as follows by the third change notification processing executed in the registration support server 11 as explained above. That is, the number of purchased articles is changed to the eat-in non-use number of articles. The tax inclusive price is changed to a tax inclusive price after the number of purchased article change. The update flag Fd is changed from “0” to “1”. Further, the commodity details data of the purchase commodity for which the eat-in declaration is performed is copied to the transaction file 51. The tax rate of the commodity details data after change is changed from the reduced tax rate to the standard tax rate. The number of purchased articles is changed to the number of eat-in use articles. The tax inclusive price is changed from a tax inclusive price of the reduced tax rate to a tax inclusive price of the standard tax rate. Not only the update flag Fd but also the in-store flag Fb is changed from “0” to “1”.

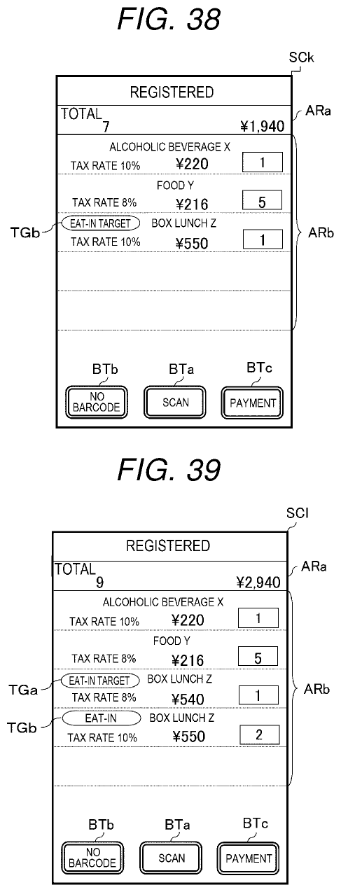

Referring back to FIG. 15, in ACT 73, the processor 41 that controlled the transmission of the first change notification command, the second change notification command, or the third change notification command waits for a details response command. If receiving the details response command via the wireless unit 46, the processor 41 proceeds to ACT 24 in FIG. 11. In ACT 24, the processor 41 executes details analysis processing. Subsequently, in ACT 25, the processor 41 executes registration screen editing processing. In ACT 31, the processor 41 switches the screen of the touch panel 44 to a registration screen SCk (see FIG. 38) or a registration screen SCl (see FIG. 39) and returns to the waiting state in ACT 32 to ACT 35.

FIG. 38 is the registration screen SCk in the case in which the second change notification command is transmitted because the customer touches the OK button BTh on the eat-in setting screen SCi illustrated in FIG. 36. In this case, commodity details data, the in-store flag Fb of which is “1” and the cancellation flag Fc of which is “0”, is included in the details response command as commodity details data of the purchase commodity “box lunch Z” for which the eat-in declaration is performed. As a result, as illustrated in FIG. 38, a tag TGb with a tag name “eat-in” is displayed in red characters in the details list display section ARb together with a commodity name, the standard tax rate “10%”, a tax inclusive price “550 yen (¥550)”, and the like of the purchase commodity “box lunch Z”. Since the tag TGb with the tag name “eat-in” is displayed, the customer can recognize that the purchase commodity “box lunch Z” is a commodity that the customer declares to eat and drink in the eat-in area.

FIG. 39 is the registration screen SCl in the case in which the third change notification command is transmitted because the customer touches the OK button BTh after changing the number of articles of the eat-in-number-of-articles display section ARe from “3” to “2”. In this case, commodity details data before change and commodity details data after change of the purchase commodity “box lunch Z” for which the eat-in declaration is performed are included in the details response command.

In the commodity details data before change, the number of purchased articles is “1”, a tax rate is the reduced tax rate of 8%, and the in-store flag Fb is “0”. Accordingly, the tag TGa with the tag name “eat-in target” is displayed in black characters in the details list display section ARb together with the commodity name, the reduced tax rate “8%”, a tax inclusive price “540 yen (¥540)”, and the like of the purchase commodity “box lunch Z”.

In the commodity details data after change, the number of purchased articles is “2”, a tax rate is the standard tax rate of 10%, the in-store flag Fb is “1”, and the cancellation flag Fc is “0”. Accordingly, the tag TGb with the tag name “eat-in” is displayed in red characters in the details list display section ARb together with the commodity name, the standard tax rate “10%”, and the tax inclusive price “550 yen (¥550)”, and the like of the purchase commodity “lunch box Z”.

Since the tag TGa with the tag name “eat-in target” and the tag TGb with the tag name “eat-in” are displayed in this way, the customer can recognize that the purchase commodity “box lunch Z” is a commodity that the customer declares to, among three articles to be purchased, eat and drink two articles in the eat-in area and take out one article.

The touch panel 44 functioning as the display unit displays, about a purchase commodity for which a tax rate change instruction is received by the receiving unit, commodity details data including a tax rate after change, that is, the standard tax rate of 10%. The touch panel 44 displays, for commodity details data of a purchase commodity (a first transaction target commodity) for which a tax rate change instruction is received by the receiving unit, the tag TGb with the tag name “eat-in” to display the commodity details data to be distinguishable from commodity details data of a purchase commodity (a second transaction target commodity) for which the tax rate change instruction is not received. Further, the touch panel 44 displays, for commodity details data of a purchase commodity (a third transaction target commodity) for which the tax rate change instruction can be received, the tag TGb with the tag name “eat-in target” to display the commodity details data to be distinguishable from commodity details data of a purchase commodity (a fourth transaction target commodity) for which the tax rate change instruction cannot be received.

Referring back to FIG. 12, if the in-store flag Fb included in the commodity details data of the selected purchase commodity is “1”, that is, the eat-in declaration is performed for the purchase commodity in ACT 37, the processor 41 proceeds to ACT 38. In ACT 38, the processor 41 checks the cancellation flag Fc included in the commodity details data. If the cancellation flag Fc is “1”, that is, a commodity for which the eat-in declaration is already cancelled is selected, the processor 41 returns to ACT 32. The processor 41 enters the waiting state in ACT 32 to ACT 35.

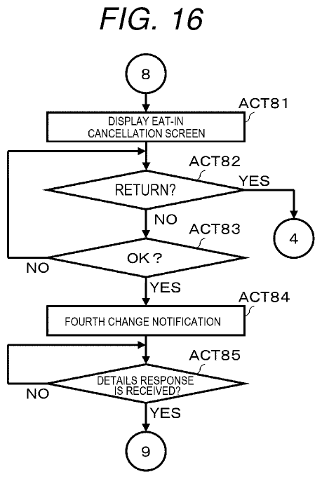

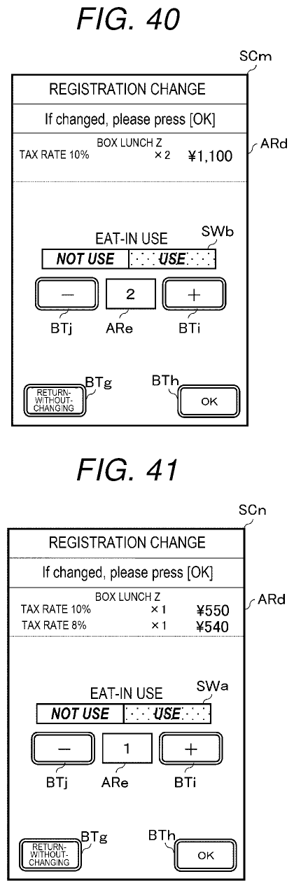

On the other hand, if the cancellation flag Fc is “0”, that is, a purchase commodity for which the eat-in declaration is performed is selected, the processor 41 proceeds to ACT 81 in FIG. 16. In ACT 81, the processor 41 switches the screen of the touch panel 44 from the registration screen SCl to an eat-in cancellation screen SCm (see FIG. 40).

FIG. 40 is an example of the eat-in cancellation screen SCm in the case in which the purchase commodity “box lunch Z” for which the tag TGb with the tag name “eat-in” is displayed on the registration screen SCl illustrated in FIG. 39 is selected. On the eat-in cancellation screen SCm, an eat-in number-of-articles display section ARe, which is the used-number-of-articles designating section, the addition button BTi, and the subtraction button BTj are disposed together with the switch SWb that can be switched from “use eat-in” to “not use eat-in”. The return-without-changing button BTg and the OK button BTh are disposed on the eat-in cancellation screen SCm. In the details display section ARd, a tax rate after the eat-in declaration, that is, the standard tax rate “10%” imposed on the selected purchase commodity “box lunch Z” is displayed. The number of purchased articles “2 (×2)” and a tax inclusive price “1100 yen (¥1,100)” are also displayed.

For example, if the customer who checked the eat-in cancellation screen SCm changes all of the two articles of the purchase commodity “box lunch Z” for which the eat-in declaration is performed to takeout, the customer switches the switch SWb from “use eat-in” to “not use eat-in”. The customer touches the OK button BTh.

For example, if the customer takes out one article of the two articles for which the eat-in declaration is performed and eats and drinks the other one article in the eat-in area, the customer touches the subtraction button BTj once and changes the eat-in-number-of-articles display section ARe from “2” to “1” as displayed on an eat-in cancellation screen SCn illustrated in FIG. 41. Thereafter, the customer touches the OK button BTh. If stopping the cancellation of the eat-in declaration, the customer touches the return-without-changing button BTg.

FIG. 41 is an example of the eat-in cancellation screen SCn after the eat-in-number-of-articles display section ARe is changed from “2” to “1” on the eat-in cancellation screen SCm illustrated in FIG. 40. In the details display section ARd of the eat-in cancellation screen SCn, a tax rate “10%”, the number of purchased articles “1 (×1)”, and a tax inclusive price “550 yen (¥550)” for the one article of the purchase commodity “box lunch Z” for which the eat-in declaration is not cancelled and a tax rate “8%”, the number of purchased articles “1 (×1)”, and a tax inclusive price “540 yen (¥540)” for one article of the purchase commodity “box lunch Z” for which the eat-in declaration is cancelled are displayed.

The processor 41 that displayed the eat-in cancellation screen SCm or the eat-in cancellation screen SCn waits for the return-without-changing button BTg to be touched in ACT 82 or the OK button BTh to be touched in ACT 83. If the return-without-changing button BTg is touched in the waiting state in ACT 82 and ATC 83, the processor 41 returns to ACT 31 in FIG. 12. That is, the processor 41 returns the screen of the touch panel 44 to the immediately preceding registration screen SCl.

If the OK button BTh is touched in the waiting state in ACT 82 and ACT 83, in ACT 84, the processor 41 controls the wireless unit 46 to perform fourth change notification. According to the control, the wireless unit 46 wirelessly transmits a fourth change notification command. The fourth change notification command is received by the access point 27 and transmitted to the registration support server 11 via the router 26 of the POS system 20. A commodity code and the number of purchased articles (the number of cancelled articles) of a purchase commodity for which the eat-in declaration is cancelled are included in the fourth change notification command. That is, in FIG. 40, if the OK button BTh is touched after the switch SW is switched, a commodity code and the number of cancelled articles “2” of the purchase commodity “box lunch Z” are included in the fourth change notification command. In FIG. 41, if the OK button BTh is touched after the eat-in-number-of-articles display section ARe is changed from “2” to “1”, the commodity code and the number of cancelled articles “1” of the purchase commodity “box lunch Z” are included in the fourth change notification command. A transaction identification code stored in the information terminal 40 is also included in the fourth change notification command.

In the registration support server 11 that receives the fourth change notification command, fourth change notification processing is executed.

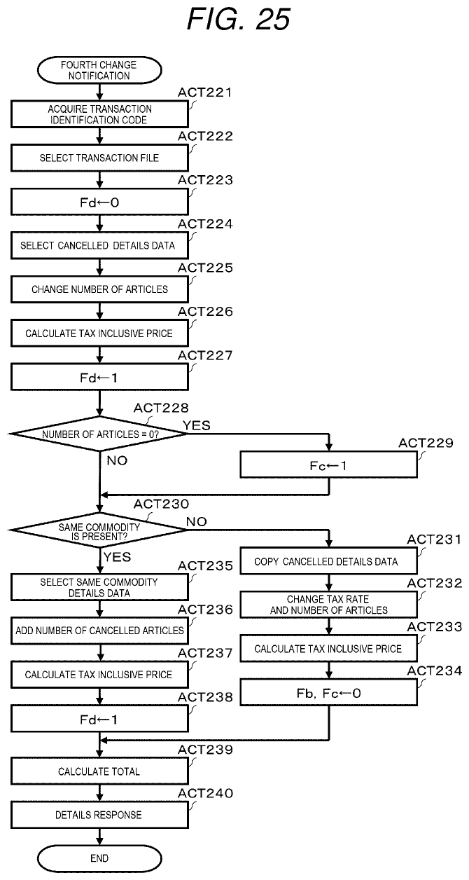

FIG. 25 is a flowchart illustrating a main part procedure of the fourth change notification processing. If receiving the fourth change notification command via the communication interface 115, in ACT 221, the processor 111 of the registration support server 11 acquires the transaction identification code from the fourth change notification command. In ACT 222, the processor 111 selects the transaction file 51 in which the transaction identification code is saved.

In ACT 223, the processor 111 sets all of the update flags Fd of individual commodity details data stored in the transaction file 51 to “0”. Subsequently, in ACT 224, the processor 111 selects commodity details data of the commodity code included in the fourth change notification command out of the commodity details data stored in the transaction file 51. In the following explanation, the selected commodity details data is referred to as cancelled commodity details data (ninth data).

In ACT 225, the processor 111 subtracts the number of cancelled article included in the fourth change notification command from the number of purchased articles of the cancelled commodity details data. In ACT 226, the processor 111 calculates a tax inclusive price based on a price, a tax rate, and the number of purchased articles after change of the cancelled commodity details data. In ACT 227, the processor 111 sets the update flag Fd of the same commodity details data to “1”.

In ACT 228, the processor 111 checks whether the number of purchased articles of the cancelled commodity details data is “0”. If the number of purchased articles is “0”, that is, all of the eat-in declarations for the purchase commodities relating to the cancelled commodity details data are cancelled, the processor 111 proceeds to ACT 229. In ACT 229, the processor 111 sets the cancellation flag Fc of the cancelled commodity details data to “1”. The processor 111 proceeds to ACT 230.

If the number of purchased articles is larger than “0”, that is, if a part of the eat-in declarations for the purchase commodities relating to the cancelled commodity details data is cancelled, the processor 111 skips the processing in ACT 229 and proceeds to ACT 230.

In ACT 230, the processor 111 checks whether other commodity details data, a commodity code, a classification code, a commodity name, and a price of which coincide with those of the cancelled commodity details data, is stored in the transaction file 51.

If the relevant other commodity details data is not stored in the list memory 61, the processor 111 proceeds to ACT 231. In ACT 231, the processor 111 copies the cancelled commodity details data on the list memory 61. In ACT 232, the processor 111 changes a tax rate of the copied cancelled commodity details data to the reduced tax rate of 8% and changes the number of purchased articles to the number of cancelled articles included in the fourth change notification command. In ACT 233, the processor 111 calculates a tax inclusive price based on a price, a tax rate, and the number of purchased articles after change of the copied cancelled commodity details data. In ACT 234, the processor 111 sets the in-store flag Fb and the cancellation flag Fc of the copied cancelled commodity details data to “0”. The update flag Fd is set to “1” in the processing in ACT 227. That is, about a purchase commodity for which the eat-in declaration is cancelled, the processor 111 adds, to the transaction file 51, commodity details data corresponding to a case in which the reduced tax rate is imposed.

On the other hand, if the same commodity details data is present in ACT 230, the processor 111 proceeds to ACT 235. In ACT 235, the processor 111 selects the same commodity details data. In ACT 236, the processor 111 adds the number of cancelled articles included in the fourth change notification command to the number of purchased articles of the same commodity details data. In ACT 237, the processor 111 calculates a tax inclusive price based on a price, a tax rate, and the number of purchased articles after change of the same commodity details data. In ACT 238, the processor 111 sets the update flag Fd of the same commodity details data to “1”. That is, the processor 111 adds commodity details data of a purchase commodity for which the eat-in declaration is cancelled to commodity details data of the purchase commodity corresponding to a case in which the reduced tax rate is imposed.

If finishing the processing in ACT 234 or ACT 238, the processor 111 proceeds to ACT 239. In ACT 239, the processor 111 recalculates the total number of articles, the total amount, and the price-cut total amount of the transaction file 51. If finishing the processing explained above, in ACT 240, the processor 111 transmits a details response command to the information terminal 40 at a fourth change notification command transmission source.

By the fourth change notification processing executed in the registration support server 11 as explained above, the number of purchased articles of the commodity details data of the purchase commodity for which the eat-in declaration is cancelled, that is, the cancelled commodity details data is changed to the number of articles obtained by subtracting the number of cancelled articles from the number of purchased articles. As a result, if the number of purchased articles changes to “0”, the cancellation flag Fc of the commodity details data changes to “1”.

If other commodity details data, a commodity code, a classification code, a commodity name, and a price of which coincide with those of the cancelled commodity details data, is not stored in the transaction file 51, commodity details data, a tax rate of which is the reduced tax rate and the number of purchased articles is the number of cancelled articles, is added to the transaction file 51 as the commodity details data of the purchase commodity for which the eat-in declaration is cancelled. The in-store flag Fb and the cancellation flag Fc of the added commodity details data are “0”.

On the other hand, if other commodity details data, a commodity code, a classification code, a commodity name, and a price of which coincide with those of the cancelled commodity details data, is stored in the transaction file 51, the number of cancelled articles is added to the number of purchased articles of the commodity details data.

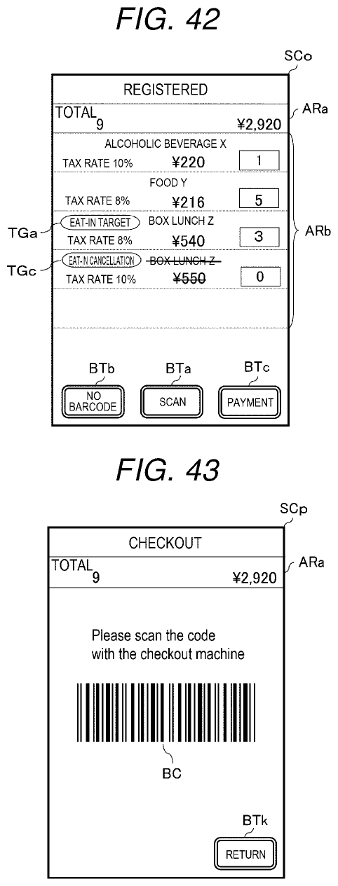

Referring back to FIG. 16, in ACT 85, the processor 41 that controlled the transmission of the fourth change notification command waits for a details response command. If receiving the details response command via the wireless unit 46, the processor 41 proceeds to ACT 24 in FIG. 11. In ACT 24, the processor 41 executes details analysis processing. Subsequently, in ACT 25, the processor 41 executes registration screen editing processing. In ACT 42, the processor 41 displays a registration screen SCo (see FIG. 42) and returns to the waiting state in ACT 32 to ACT 35.

FIG. 42 is an example of the registration screen SCo after the switch SW is switched from “use eat-in” to “not use eat-in” on the eat-in cancellation screen SCm illustrated in FIG. 40. That is, the registration screen SCo is in a case in which the customer purchases three articles of the purchase commodity “box lunch Z” that is allowed to be eaten and drunk in the eat-in area and performs the eat-in declaration for two articles among the three articles but cancels the eat-in declaration before checkout. As illustrated in FIG. 42, on the registration screen SCo, the number of purchased articles of the purchase commodity “box lunch Z” with the reduced tax rate of 8%, which is “1” on the registration screen SCl illustrated in FIG. 39, is changed to “3”. The display “8%” of the reduced tax rate and the tag TGa with the tag name “eat-in target” are not changed.

On the other hand, the number of purchased articles of the purchase commodity “box lunch Z” with the standard tax rate of 10%, which is “2” on the registration screen SCl, is changed to “0”. As a result, cancellation processing is executed. Cancellation lines are displayed on a commodity name and a tax inclusive price of the purchase commodity “box lunch Z”. A tag TGc with a tag name “eat-in cancellation” is displayed instead of the tag TGb with the tag name “eat-in”. The display “10%” of the standard tax rate is not changed.

The customer can confirm that the eat-in declaration for the purchase commodity “box lunch Z” is surely cancelled and a tax rate of a tax imposed on the purchase commodity “box lunch Z” is the reduced tax rate of 8%.

The touch panel 44 functioning as the display unit displays, to be distinguishable, for example, using a cancellation line, commodity details data of a purchase commodity for which cancellation of a tax rate change instruction is received by the receiving unit.

The customer finishing shopping touches the payment button BTc of the registration screen SCo.

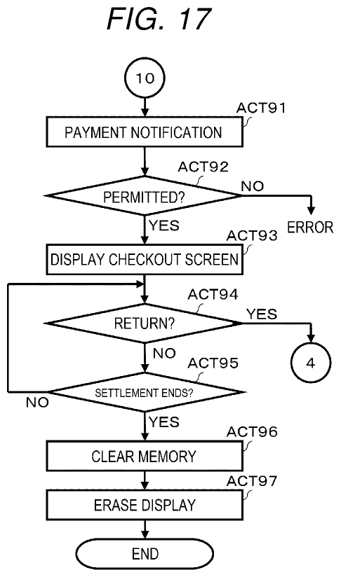

If the payment button BTc is touched, the processor 41 in the waiting state in ACT 32 to ACT 35 in FIG. 12 proceeds to ACT 91 in FIG. 17. In ACT 91, the processor 41 controls the wireless unit 46 to perform payment notification. According to the control, the wireless unit 46 wirelessly transmits a payment notification command. The payment notification command is received by the access point 27 and transmitted to the registration support server 11 via the router 26 of the POS system 20. A transaction identification code is included in the payment notification command.

In the registration support server 11 that receives the payment notification command, payment notification processing is executed.

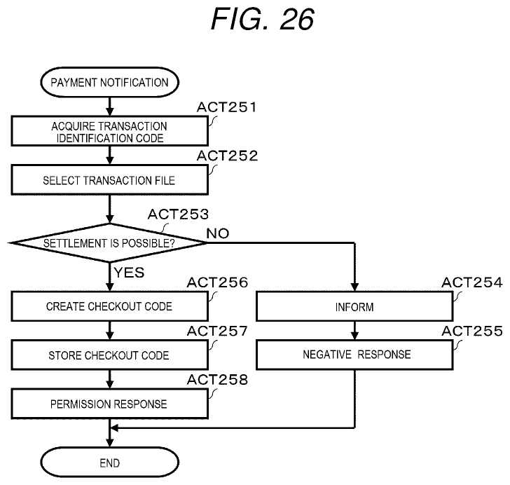

FIG. 26 is a flowchart illustrating a main part procedure of the payment notification processing. If receiving the payment notification command via the communication interface 115, in ACT 251, the processor 111 of the registration support server 11 acquires the transaction identification code from the payment notification command. In ACT 252, the processor 111 selects the transaction file 51 in which the transaction identification code is saved.

In ACT 253, the processor 111 checks whether it is possible to analyze data saved in the transaction file 51 and perform settlement. Details data in an error state remains, for example, about a commodity, a commodity name, a price, and the like of which cannot be read out with respect to a commodity code. In this case, it is not possible to perform settlement.

If it is not possible to perform settlement, the processor 111 proceeds to ACT 254. In ACT 254, the processor 111 informs a store terminal used for monitoring by an attendant that a customer purchasing an error commodity declares settlement. In ACT 255, the processor 111 transmits a negative response command to the information terminal 40 at a payment notification command transmission source. The informed attendant takes measures for, for example, checking a purchase commodity of the customer.

On the other hand, if it is possible to perform settlement, the processor 111 proceeds to ACT 256. In ACT 256, the processor 111 creates a unique checkout code. In ACT 257, the processor 111 saves the checkout code in the transaction file 51. In ACT 258, the processor 111 transmits a permission response command to the information terminal 40 at a payment notification command transmission source.

Referring back to FIG. 17, in ACT 92, the processor 41 that controlled the transmission of the payment notification command waits for a response command. If receiving the negative response command from the registration support server 11, the processor 41 performs error processing. For example, the processor 41 causes the touch panel 44 to display an error message such as “You cannot settle by yourself. Please settle in a manned checkout machine”.

If receiving the permission response command, the processor 41 proceeds to ACT 93. In ACT 93, the processor 41 switches the screen of the touch panel 44 from the registration screen to a checkout screen SCp (see FIG. 43).

FIG. 43 is an example of the checkout screen SCp in the case in which the payment button BTc is touched on the registration screen SCo illustrated in FIG. 42. As illustrated, a checkout code is displayed as a barcode BC on the checkout screen SCp. A return button BTk is disposed on the checkout screen SCp.

The processor 41 waits for the return button BTk to be touched in ACT 94 or a settlement end response command to be received in ACT 95. If the return button BTk is touched, the processor 41 returns to ACT 31 in FIG. 12. The processor 41 returns the screen of the touch panel 44 from the checkout screen SCp to the immediately preceding registration screen SCo. The processor 41 enters the waiting state in ACT 32 to ACT 35 in FIG. 12.

If the customer finishes checkout in the dedicated checkout machine 24, the settlement end response command is sent from the registration support server 11. The customer who checks the checkout screen SCp scans the barcode BC of the checkout screen SCp with a scanner of the dedicated checkout machine 24. Then, a settlement request command is transmitted from the dedicated checkout machine 24 to the registration support server 11. Data of the barcode BC, that is, the checkout code is included in the settlement request command.

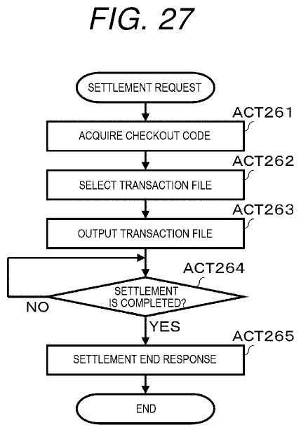

The processor 111 of the registration support server 11 that receives the settlement request command starts settlement request processing of a procedure illustrated in FIG. 27. That is, in ACT 261, the processor 111 acquires the checkout code from the settlement request command. In ACT 262, the processor 111 selects the transaction file 51 in which the transaction identification code is saved.

In ACT 263, the processor 111 transmits data of the transaction file 51 to the dedicated checkout machine 24 at a settlement request command transmission source. Consequently, content of a transaction is displayed on a display of the dedicated checkout machine 24. Therefore, the customer pays a price after checking the content. If the payment of the price is completed, a settlement completion command is transmitted from the dedicated checkout machine 24 to the registration support server 11.

In ACT 264, the processor 111 that transmitted the data of the transaction file 51 to the dedicated checkout machine 24 waits for the settlement completion command. If receiving the settlement completion command, the processor 111 proceeds to ACT 265. In ACT 265, the processor 111 transmits a settlement end response command to the information terminal 40 specified by the transaction identification code of the transaction file 51.

Referring back to FIG. 17, if receiving the settlement end response command, the processor 41 of the information terminal 40 that displayed the checkout screen SCp proceeds to ACT 96. In ACT 96, the processor 41 clears the list memory 61 and the total memory 62. In ACT 97, the processor 41 erases the checkout screen SCp. Then, the shopping performed by the customer himself or herself using the information terminal 40 ends.

[Action Effects of the Information Terminal]

As explained above in detail, in the information terminal 40, if the purchase commodity attached with the tag TGa with the tag name “eat-in target” is selected by the customer on the registration screen displayed on the touch panel 44, the screen of the touch panel 44 transitions to the eat-in setting screen. If the customer switches the switch SWa from “not use eat-in” to “use eat-in”, the second change notification command or the third change notification command is output to the registration support server 11. In the registration support server 11, the tax rate of the tax imposed on the purchase commodity is changed from the reduced tax rate of 8% to the standard tax rate of 10% and processed. Therefore, with the information terminal 40, it is possible to easily cope with the tax rate change of the tax imposed on the purchase commodity without intention confirmation by a store clerk.

Moreover, about the purchase commodity for which the tax rate change instruction is received, the commodity details data including the tax rate after change is displayed on the registration screen. Therefore, the customer can recognize that the tax rate change is surely instructed.

On the registration screen, the commodity details data of the purchase commodity for which the tax rate change instruction is received and the commodity details data of the purchase commodity for which the tax rate change instruction is not received are distinguishably displayed. For example, the tag TGb with the tag name “eat-in” is displayed for the commodity details data of the purchase commodity for which the tax rate change instruction is received. The tag TGb is not displayed for the commodity details data of the purchase commodity for which the tax rate change instruction is not received. Therefore, the customer can easily distinguish the purchase commodity for which the tax rate change instruction is performed and the purchase commodity for which the tax rate change instruction is not performed.

On the registration screen, the commodity details data of the purchase commodity for which the tax rate change instruction can be received and the commodity details data of the purchase commodity for which the tax rate change instruction cannot be received are distinguishably displayed. For example, the tag TGa with the tag name “eat-in target” is displayed for the commodity details data of the purchase commodity for which the tax rate change instruction can be received. The tag TGa is not displayed for the commodity details data of the purchase commodity for which the tax rate change instruction cannot be received. Therefore, the customer can easily distinguish the purchase commodity for which the tax rate change can be instructed and the purchase commodity for which the tax rate change cannot be instructed.

Further, on the registration screen, the commodity details data of the purchase commodity for which the cancellation of the tax rate change instruction is received is distinguishably displayed. For example, the tag TGc with the tag name “eat-in cancellation” is displayed for the commodity details data of the purchase commodity for which the cancellation of the tax rate change instruction is received. The cancellation lines are displayed on the commodity name and the like. Therefore, the customer can easily specify the purchase commodity for which the tax rate change instruction is cancelled.

Moreover, a space for displaying the tag TGa, the tag TGb, or the tag TGc only has to be present on the registration screen. Therefore, the display of the tag TGa, the tag TGb, or the tag TGc can be easily carried out even if there is limitation in a screen size of the touch panel 44 in the portable information terminal 40.

[Modifications]

In the embodiment, the smartphone is assumed as the information terminal 40. The information terminal 40 may be, for example, a tablet terminal attached to a shopping cart or a portable terminal rent out to a customer by a store.

The commodity registration device is not limited to the information terminal 40. For example, a self-service POS terminal with which a customer himself or herself performs registration operation and checkout operation for a purchase commodity may be a form of the commodity registration device.

In the embodiment, the tag TGa, the tag TGb, or the tag TGc is displayed together with the commodity name, the price, the tax rate, and the like of the commodity details data to make it possible to distinguish the commodity details data from the other commodity details data for which a tag is not displayed. Concerning this point, information other than the tag, for example, a mark may be used to make it possible to distinguish the commodity details data. In the embodiment, the character colors of the tag TGa, the tag TGb, and the tag TGc are changed. Concerning this point, the character colors do not always have to be changed. Alternatively, background colors of the tag TGa, the tag TGb, and the tag TGc may be differentiated to make it easy to distinguish the tag TGa, the tag TGb, and the tag TGc.

In the embodiment, the cancellation processing is the processing for displaying the cancellation lines on the commodity name and the tax inclusive price. Concerning this point, for example, characters of the commodity name and the tax inclusive price may be displayed in light gray to indicate that the commodity name and the tax inclusive price are already cancelled.

In the embodiment, the price set in the commodity master 14 is the tax exclusive price not including the tax amount. Concerning this point, the price may be a tax inclusive price including the tax amount.

In the embodiment, the case is illustrated where the instruction for changing the low tax rate (the reduced tax rate) to the high tax rate (the standard tax rate) is received. Concerning this point, an instruction for changing the high tax rate to the low tax rate may be received.

Besides, the several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A commodity registration device, comprising:
an input component to which commodity data used to specify a transaction target commodity is input;
a display configured to display commodity details data including a tax rate of a tax imposed on the transaction target commodity specified by the commodity data input via the input component;
a receiving component configured to receive a tax rate change instruction for the tax imposed on the transaction target commodity for which the commodity details data is displayed on the display; and
an output component configured to output the commodity data used to specify the transaction target commodity for which the tax rate change instruction is received by the receiving component.

2. The commodity registration device according to claim 1, wherein, about the transaction target commodity for which the tax rate change instruction is received by the receiving component, the display displays commodity details data including a tax rate after change.

3. The commodity registration device according to claim 1, wherein the display displays commodity details data of a first transaction target commodity for which the tax rate change instruction is received by the receiving component distinguishably from commodity details data of a second transaction target commodity for which the tax rate change instruction is not received.

4. The commodity registration device according to claim 3, wherein the display displays commodity details data of a third transaction target commodity for which the tax rate change instruction received distinguishably from commodity details data of a fourth transaction target commodity for which the tax rate change instruction is not received.

5. The commodity registration device according to claim 1, wherein
the receiving component receives cancellation of the tax rate change instruction,
the output component outputs the commodity data used to specify the transaction target commodity for which the cancellation of the tax rate change instruction is received, and
the display unit distinguishably displays commodity details data of the transaction target commodity for which the cancellation of the tax rate change instruction is received by the receiving component.

6. The commodity registration device according to claim 1, further comprising:
a registration support device configured to:
perform registration processing for commodity sales data based on a code of a purchase commodity input, and
according to a checkout instruction, generate or transmit checkout data necessary for settlement of a transaction with a customer.

7. The commodity registration device according to claim 1, wherein
the commodity data comprises at least one of a commodity code, a classification code, a commodity name, a price, and a tax class.

8. A commodity registration method for a commodity registration device including an input component to which commodity data used to specify a transaction target commodity is input, the commodity registration method comprising:
causing a display to display commodity details data including a tax rate of a tax imposed on the transaction target commodity specified by the commodity data input via the input component;
receiving a tax rate change instruction for the tax imposed on the transaction target commodity for which the commodity details data is displayed on the display; and
outputting the commodity data used to specify the transaction target commodity for which the tax rate change instruction is received.

9. The commodity registration method according to claim 8, further comprising:
about the transaction target commodity for which the tax rate change instruction is received, displaying commodity details data including a tax rate after change.

10. The commodity registration method according to claim 8, further comprising:
displaying commodity details data of a first transaction target commodity for which the tax rate change instruction is received distinguishably from commodity details data of a second transaction target commodity for which the tax rate change instruction is not received.

11. The commodity registration method according to claim 10, further comprising:
displaying commodity details data of a third transaction target commodity for which the tax rate change instruction received distinguishably from commodity details data of a fourth transaction target commodity for which the tax rate change instruction is not received.

12. The commodity registration method according to claim 8, further comprising:
receiving cancellation of the tax rate change instruction;
outputting the commodity data used to specify the transaction target commodity for which the cancellation of the tax rate change instruction is received; and
distinguishably displaying commodity details data of the transaction target commodity for which the cancellation of the tax rate change instruction is received.

13. The commodity registration method according to claim 8, further comprising:
performing registration processing for commodity sales data based on a code of a purchase commodity input; and
according to a checkout instruction, generating or transmitting checkout data necessary for settlement of a transaction with a customer.

14. An automated variable tax rate commodity registration device, comprising:
an input component to which commodity data used to specify a transaction target commodity is input;
a display configured to display commodity details data including a tax rate of a tax imposed on the transaction target commodity specified by the commodity data input via the input component;
a receiving component configured to receive a tax rate change instruction for the tax imposed on the transaction target commodity for which the commodity details data is displayed on the display; and
an output component configured to output the commodity data used to specify the transaction target commodity for which the tax rate change instruction is received by the receiving component.

15. The automated variable tax rate commodity registration device according to claim 14, wherein, about the transaction target commodity for which the tax rate change instruction is received by the receiving component, the display displays commodity details data including a tax rate after change.

16. The automated variable tax rate commodity registration device according to claim 14, wherein the display displays commodity details data of a first transaction target commodity for which the tax rate change instruction is received by the receiving component distinguishably from commodity details data of a second transaction target commodity for which the tax rate change instruction is not received.

17. The automated variable tax rate commodity registration device according to claim 16, wherein the display displays commodity details data of a third transaction target commodity for which the tax rate change instruction received distinguishably from commodity details data of a fourth transaction target commodity for which the tax rate change instruction is not received.

18. The automated variable tax rate commodity registration device according to claim 14, wherein
the receiving component receives cancellation of the tax rate change instruction,
the output component outputs the commodity data used to specify the transaction target commodity for which the cancellation of the tax rate change instruction is received, and
the display unit distinguishably displays commodity details data of the transaction target commodity for which the cancellation of the tax rate change instruction is received by the receiving component.

19. The automated variable tax rate commodity registration device according to claim 14, further comprising:
a registration support device configured to:
perform registration processing for commodity sales data based on a code of a purchase commodity input, and
according to a checkout instruction, generate or transmit checkout data necessary for settlement of a transaction with a customer.

20. The automated variable tax rate commodity registration device according to claim 14, wherein
the commodity data comprises at least one of a commodity code, a classification code, a commodity name, a price, and a tax class.
